(19) United States
(12) Patent Application Publication
(10) Pub. No.: US 2022/0154804 A1
(43) Pub. Date: May 19, 2022

(54) GEARBOX

(71) Applicant: GENESIS ADVANCED TECHNOLOGY INC., Surrey (CA)

(72) Inventors: James Brent KLASSEN, Surrey (CA); Richard BOS, Surrey (CA)

(21) Appl. No.: 17/600,364

(22) PCT Filed: Mar. 27, 2020
(86) PCT No.: PCT/IB2020/052939

§ 371 Date: Sep. 30, 2021

Related U.S. Application Data
(60) Provisional application No. 62/827,786, filed on Apr. 1, 2019.
(60) Provisional application No. 62/828,320, filed on Apr. 2, 2019.

(51) Int. Cl. F16H 1/36; F16H 13/06; F16H 3/66; F16H 57/02; F16H 57/08

(52) U.S. Cl. CPC F16H 1/36; F16H 13/06; F16H 3/663; F16H 2200/2097; F16H 57/08; F16H 2200/0034; F16H 2200/2005; F16H 57/02

(57) ABSTRACT

A planetary gearbox with two rows of planets between an inner race and a coaxial outer race. An input gear may also mesh with the inner planets or the outer planets. To avoid unmeshing of the gears due to twisting from the applied torque, a camming effect may be used in which applied torque generates a radial preload. The gears that mesh with the input gear may do so at portions of the gears that also mesh with a corresponding one of the inner or outer race. The planets may be geared with axial portions with different helix angle. The inner race or outer race may be formed of two components geared with different helix angle to mesh with the different axial portions of the planets. By using these different components, assembly is eased as the components can be slid onto the planets axially.

### CROSS-REFERENCE TO RELATED APPLICATIONS

This patent application claims priority from U.S. Provisional Patent Appl. Ser. No. 62/827,786, filed Apr. 1, 2019 and U.S. Provisional Patent Appl. Ser. No. 62/828,320, filed Apr. 2, 2019, each of which are incorporated herein by reference in their entirety.

### BACKGROUND

In published patent application no. WO2013173928A1 a device is shown which increases torque with two rows of roller-based planets all of which are contacting two other roller-based planets and at a high enough number of planets that a low camming angle is achieved. Below this angle, the camming action which occurs when the device is loaded, increases the force between the geared or rolling members and the contact pressure at the contacts between the inner and outer planets and between the inner planets and the inner race and between the outer planets and the outer race.

Achieving a coefficient of friction that is high enough to allow this camming action to happen is a challenge, because many common material combinations, such as steel on steel, have a lower Coefficient of Friction (CF) than necessary for a typical camming angle for this device. As a result materials such as nickel alloys or other material combinations must be used to achieve a high enough CF to allow the camming angle geometry to provide a tractive pressure that is proportional to the torque being transmitted.

Another challenge with a rolling contact version is to keep the planets all equally circumferentially spaced. A rolling contact does not “clock” itself relative to the other planets, and the two rows of planets are inherently unstable if the circumferential spacing of the planets is not controlled. By unstable, what is meant is that the inner race will not stay concentric with the outer race if the planets become unequally spaced.

Another challenge of embodiments of a roller-based gearbox is that bearings are required to keep the outer race axially aligned with the inner race.

Geared devices such as conventional gear reducers will commonly use a planet carrier with shafts and bearings to position the planets. A planet carrier adds rotational mass, cost and complexity.

### BRIEF SUMMARY

There is provided a gearbox device having an inner race having an outer surface and defining an axis and an outer race having an inner surface and coaxial with the inner race. The gearbox device has a set of orbital planets including inner planets in geared contact with the outer surface of the inner race and outer planets in geared contact with the inner surface of the outer race, each and every inner planet being in geared contact with two outer planets, and each and every outer planet being in geared contact with two inner planets. There may be an input ring coaxial with the inner race and outer race and in geared contact with the inner planets or with the outer planets.

In one embodiment, one of A or B is the case in which A is the outer planets are longer than the inner planets and each outer planet has a respective first portion that meshes with the inner planets with which it is in contact, and the input ring has an outer surface that meshes with a respective second portion of each outer planet with which it is in contact, both the first portions and the second portions of the outer planets meshing with the outer race; and B is inner planets are longer than the outer planets and each inner planet has a respective first portion that meshes with the outer planets with which it is in contact, and the input ring has an inner surface that meshes with a respective second portion of each inner planet with which it is in contact, both the first portions and the second portions of the inner planets meshing with the inner race.

In another embodiment, the inner and outer planets have a length in geared contact, and the gears and races have respective diameters, selected to cause torque on the input ring to cause increased radial loading of the inner and outer planets sufficient to overcome a separating force between the gears caused by the torque on the input ring.

In another embodiment, at least one of the outer surface of the inner race and the inner surface of the outer race are formed of two angled gear surfaces having different helix angle. The two angled gear surfaces may be positioned on axially adjacent components. This arrangement may be used to enable the components to be moved axially into gear meshing contact with the planetary gears, easing assembly.

Various embodiments are directed to a gearbox comprising: a sun gear defining an inner race on an exterior surface thereof, wherein the sun gear defines an axis between a first end and an opposite second end of the sun gear; a ring gear defining an outer race on an interior surface thereof, wherein the ring gear is coaxial with the sun gear; an inner set of planets in geared contact with the inner race of the sun gear; an outer set of planets in geared contact with the outer race of the ring gear; wherein each of the inner set of planets is in geared contact with at least two of the outer set of planets and each of the outer set of planets is in geared contact with at least two of the inner set of planets; and an intermediate gear defining an intermediate race in geared contact with one of: (a) the inner set of planets or (b) the outer set of planets; and wherein one of the sun gear, the ring gear, and the intermediate gear is held stationary.

In certain embodiments, the inner set of planets each have a first axial length measured parallel to the axis of the sun gear; and the outer set of planets each have a second axial length measured parallel to the axis of the sun gear, wherein the second axial length is different than the first axial length; and wherein the intermediate race is in geared contact with a longer axial gear set of: (a) the inner set of planets or (b) the outer set of planets. In various embodiments, the inner set of planets and the outer set of planets having a length in geared contact, and the inner set of planets, the outer set of planets, the inner race, the outer race, and the intermediate race having respective diameters selected to enable torque provided via one of the sun gear, the ring gear, or the intermediate gear to cause increased radial loading of the inner set of planets and the outer set of planets sufficient to overcome a separating force caused by the torque. Moreover, in certain embodiments, the at least one of: (a) the inner set of planets or (b) the outer set of planets each have a length-to-diameter ratio greater than 1:1. In certain embodiments, the inner set of planets and the outer set of planets each comprise two differently tapered portions.

In various embodiments, the inner set of planets and the outer set of planets each define helical gears. In certain embodiments, the inner set of planets and the outer set of planets each define helical gears having a constant helix angle. Moreover, the inner set of planets and the outer set of planets may each define helical gears having differing helix angles along an axial length. In various embodiments, the inner set of planets and the outer set of planets each define herringbone gear patterns. Moreover, the intermediate gear may comprise two axially adjacent components each having a respective angled gear surface corresponding to a portion of the herringbone gear patterns, wherein the two axially adjacent components are fastened to one another. In certain embodiments, the ring gear comprises two axially adjacent components each having a respective angled gear surface corresponding to a portion of the herringbone gear patterns, wherein the two axially adjacent components are fastened to one another. Moreover, the sun gear may comprise two axially adjacent components each having a respective angled gear surface corresponding to a portion of the herringbone gear patterns, wherein the two axially adjacent components are fastened to one another.

In certain embodiments, the gearbox device further comprises at least one inner fence configured to axially constrain the inner set of planets. In various embodiments, the gearbox further comprising at least one outer fence configured to axially constrain the outer set of planets. In various embodiments, the inner race, the outer race, the intermediate race, and exterior surfaces of each of the inner set of planets and each of the outer set of planets all define a plurality of gear teeth separated from adjacent gear teeth by gear roots, and wherein at least a portion of the gear roots define radial slots. In certain embodiments, each of the inner set of planets and each of the outer set of planets are hollow.

Various embodiments are directed to a multi-stage gearbox device comprising a plurality of gearbox devices as discussed herein, wherein the plurality of gearbox devices are arranged in stages such that a first ring gear of a first gearbox device is connected to and drives a second intermediate gear of a second gearbox device.

Certain embodiments are directed to a gearbox device comprising: a sun gear defining an inner race on an exterior surface thereof, wherein the sun gear defines an axis between a first end and an opposite second end of the sun gear; a ring gear defining an outer race on an interior surface thereof, wherein the ring gear is coaxial with the sun gear; an inner set of planets in geared contact with the inner race of the sun gear; an outer set of planets in geared contact with the outer race of the ring gear; wherein each of the inner set of planets is in geared contact with at least two of the outer set of planets and each of the outer set of planets is in geared contact with at least two of the inner set of planets; and an intermediate gear defining an intermediate race in geared contact with one of: (a) the inner set of planets or (b) the outer set of planets; and wherein the inner race, the outer race, the intermediate race, and exterior surfaces of each of the inner set of planets and each of the outer set of planets all define a plurality of gear teeth having a continuous helix angle.

In various embodiments, the gearbox further comprising at least one inner fence attached to the sun gear and configured to constrain axial movement of the inner set of planets. In certain embodiments, the at least one inner fence comprises two inner fences each secured on opposing axial ends of the sun gear. In various embodiments, at least one outer fence attached to the ring gear and configured to constrain axial movement of the outer set of planets. In certain embodiments, the at least one outer fence comprises two outer fences each secured on opposing axial ends of the ring gear. Moreover, each of the axial ends of the inner set of planets may have a hemispherical shape and the at least one inner fence has a curved shape corresponding to the hemispherical shape of the axial ends of the inner set of planets. In various embodiments, the intermediate gear is an output ring and one of the sun gear or the ring gear is driven by an input motor. In certain embodiments, the inner set of planets each have a first axial length measured parallel to the axis of the sun gear; and the outer set of planets each have a second axial length measured parallel to the axis of the sun gear, wherein the second axial length is different than the first axial length; and wherein the intermediate race is in geared contact with a longer axial gear set of: (a) the inner set of planets or (b) the outer set of planets. Moreover, the at least one of: (a) the inner set of planets or (b) the outer set of planets each have a length-to-diameter ratio greater than 1:1. In certain embodiments, each of the inner set of planets and each of the outer set of planets are hollow.

Various embodiments are directed to a gearbox device comprising: a sun gear defining an inner race on an exterior surface thereof, wherein the sun gear defines an axis between a first end and an opposite second end of the sun gear; a ring gear defining an outer race on an interior surface thereof, wherein the ring gear is coaxial with the sun gear; an inner set of planets in geared contact with the inner race of the sun gear; an outer set of planets in geared contact with the outer race of the ring gear; wherein each of the inner set of planets is in geared contact with at least two of the outer set of planets and each of the outer set of planets is in geared contact with at least two of the inner set of planets; and an intermediate gear defining an intermediate race in geared contact with one of: (a) the inner set of planets or (b) the outer set of planets; at least one inner fence attached to the sun gear and configured to axially constrain the inner set of planets; and at least one outer fence attached to the ring gear and configured to axially constrain the outer set of planets.

In various embodiments, each of the axial ends of the inner set of planets has a hemispherical shape and the at least one inner fence has a curved shape corresponding to the hemispherical shape of the axial ends of the inner set of planets. Moreover, each of the axial ends of the outer set of planets has a hemispherical shape and the at least one outer fence has a curved shape corresponding to the hemispherical shape of the axial ends of the outer set of planets. In certain embodiments, the inner set of planets each have a first axial length measured parallel to the axis of the sun gear; and the outer set of planets each have a second axial length measured parallel to the axis of the sun gear, wherein the second axial length is different than the first axial length; and wherein the intermediate race is in geared contact with a longer axial gear set of: (a) the inner set of planets or (b) the outer set of planets.

In certain embodiments, the intermediate gear is an output gear, and one of the sun gear or the ring gear is driven by an input motor. In various embodiments, the at least one of: (a) the inner set of planets or (b) the outer set of planets each have a length-to-diameter ratio greater than 1:1. Moreover, the inner set of planets and the outer set of planets each define helical gears. In certain embodiments, the inner race, the outer race, the intermediate race, and exterior surfaces of each of the inner set of planets and each of the outer set of planets all define a plurality of gear teeth separated from adjacent gear teeth by gear roots, and wherein at least a portion of the gear roots define radial slots. In certain embodiments, each of the inner set of planets and each of the outer set of planets are hollow.

Certain embodiments are directed to a gearbox device comprising: a sun gear defining an inner race on an exterior surface thereof, wherein the sun gear defines an axis between a first end and an opposite second end of the sun gear; a ring gear defining an outer race on an interior surface thereof, wherein the ring gear is coaxial with the sun gear; an inner set of planets in geared contact with the inner race of the sun gear; an outer set of planets in geared contact with the outer race of the ring gear; wherein each of the inner set of planets is in geared contact with at least two of the outer set of planets and each of the outer set of planets is in geared contact with at least two of the inner set of planets; and an intermediate gear defining an intermediate race in geared contact with one of: (a) the inner set of planets or (b) the outer set of planets; and wherein each of the inner set of planets and each of the outer set of planets have a stiffness greater than a stiffness of each of the sun gear, the ring gear, and the intermediate gear, such that one or more of the sun gear, the ring gear, or the intermediate gear deforms to balance radial loads on the inner set of planets and the outer set of planets.

In certain embodiments, each of the inner set of planets and each of the outer set of planets comprise a metal material. Moreover, one or more of the sun gear, the ring gear, and the intermediate gear comprise a plastic material.

In various embodiments, the inner set of planets each have a first axial length measured parallel to the axis of the sun gear; and the outer set of planets each have a second axial length measured parallel to the axis of the sun gear, wherein the second axial length is different than the first axial length; and wherein the intermediate race is in geared contact with a longer axial gear set of: (a) the inner set of planets or (b) the outer set of planets. In certain embodiments, the at least one of: (a) the inner set of planets or (b) the outer set of planets each have a length-to-diameter ratio greater than 1:1. In various embodiments, the inner set of planets and the outer set of planets each comprise two differently tapered portions. In certain embodiments, the inner set of planets and the outer set of planets each define helical gears. In certain embodiments, the inner set of planets and the outer set of planets each define helical gears having a constant helix angle. In various embodiments, the inner set of planets and the outer set of planets each define helical gears having differing helix angles along an axial length. Moreover, the inner set of planets and the outer set of planets each define herringbone gear patterns. In certain embodiments, the intermediate gear comprises two axially adjacent components each having a respective angled gear surface corresponding to a portion of the herringbone gear patterns, wherein the two axially adjacent components are fastened to one another.

In various embodiments, the ring gear comprises two axially adjacent components each having a respective angled gear surface corresponding to a portion of the herringbone gear patterns, wherein the two axially adjacent components are fastened to one another. In various embodiments, the sun gear comprises two axially adjacent components each having a respective angled gear surface corresponding to a portion of the herringbone gear patterns, wherein the two axially adjacent components are fastened to one another. Moreover, the gearbox may further comprise at least one inner fence configured to axially constrain the inner set of planets. In various embodiments, the gearbox device further comprising at least one outer fence configured to axially constrain the outer set of planets. In certain embodiments, the inner race, the outer race, the intermediate race, and exterior surfaces of each of the inner set of planets and each of the outer set of planets all define a plurality of gear teeth separated from adjacent gear teeth by gear roots, and wherein at least a portion of the gear roots define radial slots. Moreover, each of the inner set of planets and each of the outer set of planets may be hollow.

Various embodiments are directed to a gearbox device comprising: a sun gear defining an inner race on an exterior surface thereof, wherein the sun gear defines an axis between a first end and an opposite second end of the sun gear; a ring gear defining an outer race on an interior surface thereof, wherein the ring gear is coaxial with the sun gear; an inner set of planets in geared contact with the inner race of the sun gear; an outer set of planets in geared contact with the outer race of the ring gear; wherein each of the inner set of planets is in geared contact with at least two of the outer set of planets and each of the outer set of planets is in geared contact with at least two of the inner set of planets; and an intermediate gear defining an intermediate race in geared contact with one of: (a) the inner set of planets or (b) the outer set of planets; and wherein each of the inner set of planets and each of the outer set of planets have a stiffness less than a stiffness of each of the sun gear, the ring gear, and the intermediate gear, such that one or more of the sun gear, the ring gear, or the intermediate gear deforms to balance radial loads on the inner set of planets and the outer set of planets.

In certain embodiments, each of the inner set of planets and each of the outer set of planets comprise a metal material. Moreover, each of the inner set of planets and each of the outer set of planets are hollow. In various embodiments, each of the inner set of planets and each of the outer set of planets comprise a plastic material. Moreover, in certain embodiments, the inner set of planets each have a first axial length measured parallel to the axis of the sun gear; and the outer set of planets each have a second axial length measured parallel to the axis of the sun gear, wherein the second axial length is different than the first axial length; and wherein the intermediate race is in geared contact with a longer axial gear set of: (a) the inner set of planets or (b) the outer set of planets. In various embodiments, the at least one of: (a) the inner set of planets or (b) the outer set of planets each have a length-to-diameter ratio greater than 1:1. In certain embodiments, the inner set of planets and the outer set of planets each comprise two differently tapered portions. In certain embodiments, the inner set of planets and the outer set of planets each define helical gears. In various embodiments, the inner set of planets and the outer set of planets each define helical gears having a constant helix angle. In certain embodiments, the inner set of planets and the outer set of planets each define helical gears having differing helix angles along an axial length. In certain embodiments, the inner set of planets and the outer set of planets each define herringbone gear patterns. Moreover, the intermediate gear may comprise two axially adjacent components each having a respective angled gear surface corresponding to a portion of the herringbone gear patterns, wherein the two axially adjacent components are fastened to one another. In certain embodiments, the ring gear comprises two axially adjacent components each having a respective angled gear surface corresponding to a portion of the herringbone gear patterns, wherein the two axially adjacent components are fastened to one another. Moreover, the sun gear may comprise two axially adjacent components each having a respective angled gear surface corresponding to a portion of the herringbone gear patterns, wherein the two axially adjacent components are fastened to one another.

In certain embodiments, the gearbox device further comprising at least one inner fence configured to axially constrain the inner set of planets. In certain embodiments, the gearbox device further comprising at least one outer fence configured to axially constrain the outer set of planets. In various embodiments, the inner race, the outer race, the intermediate race, and exterior surfaces of each of the inner set of planets and each of the outer set of planets all define a plurality of gear teeth separated from adjacent gear teeth by gear roots, and wherein at least a portion of the gear roots define radial slots. In various embodiments, each of the inner set of planets and each of the outer set of planets are hollow.

Various embodiments are directed to a method of assembling a gearbox device, the method comprising: placing a set of outer planets in geared contact with an inner surface of an outer race; placing a set of inner planets in geared contact with the outer set of planets, each and every inner planet being in geared contact with two outer planets, and each and every outer planet being in geared contact with two inner planets; placing a first component of an inner race in geared contact with the inner planets and coaxial with the outer race, the first component having a first angled gear surface; placing a second component of an inner race in geared contact with the inner planets and coaxial with the outer race, the second component having a second angled gear surface, the first angled gear surface and the second angled gear surface having different helix angle; and placing an input gear in geared contact with the outer planets and coaxial with the outer race. In certain embodiments, the first angled gear surface and the second angled gear surface have opposite helix angles that collectively form a herringbone gear surface. In various embodiments, the input gear comprises a first input gear component having a first angled input gear surface and a second input gear component having a second angled input gear surface, and the step of placing an input gear in geared contact with the outer set of planets and coaxial with the outer race comprises placing the a first input gear component coaxial with the outer planets and with the first angled input gear surface in geared contact with the outer set of planets, and placing the a second input gear component coaxial with the outer set of planets and with the second angled input gear surface in geared contact with the outer set of planets, the first angled input gear surface and the second angled input gear surface having different helix angle.

In certain embodiments, the first angled input gear surface and the second angled input gear surface have opposite helix angle to together form a herringbone input gear surface. Moreover, the first angled input gear surface may be placed into geared contact with the outer planets before the step of placing the set of inner planets in geared contact with the outer set of planets, and the second angled input gear surface is placed into geared contact with the outer set of planets after the steps of placing the first input gear component and the second input gear component of the inner race in geared contact with the inner planets.

Moreover, certain embodiments are directed to a method of assembling a gearbox device, the method comprising the steps of: placing a set of inner planets in geared contact with an outer surface of an inner race; placing a set of outer planets in geared contact with the inner set of planets, each and every outer planet being in geared contact with two inner planets, and each and every inner planet being in geared contact with two outer planets; placing a first component of an outer race in geared contact with the inner planets and coaxial with the inner race, the first component having a first angled gear surface; placing a second component of an outer race in geared contact with the outer set of planets and coaxial with the inner race, the second component having a second angled gear surface, the first angled gear surface and the second angled gear surface having different helix angle; and placing an input gear in geared contact with the inner set of planets and coaxial with the inner race.

In certain embodiments, the first angled gear surface and the second angled gear surface have opposite helix angles collectively forming a herringbone gear surface. Moreover, according to certain embodiments, the input gear comprises a first input gear component having a first angled input gear surface and a second input gear component having a second angled input gear surface, and the step of placing an input gear in geared contact with the inner planets and coaxial with the inner race comprises placing the a first input gear component coaxial with the inner set of planets and with the first angled input gear surface in geared contact with the inner planets, and placing the a second input gear component coaxial with the inner set of planets and with the second angled input gear surface in geared contact with the inner planets, the first angled input gear surface and the second angled input gear surface having different helix angle. In various embodiments, the first angled input gear surface and the second angled input gear surface have opposite helix angle to together form a herringbone input gear surface. Moreover, in certain embodiments, the first angled input gear surface is placed into geared contact with the inner set of planets before the step of placing the set of outer planets in geared contact with the inner planets, and the second angled input gear surface is placed into geared contact with the inner set of planets after the steps of placing the first input gear component and the second input gear component of the outer race in geared contact with the outer planets.

### BRIEF DESCRIPTION OF THE SEVERAL VIEWS OF THE DRAWINGS

Reference will now be made to the accompanying drawings, which are not necessarily drawn to scale, and wherein:

FIG. 1 is a simplified schematic axial end view of a portion of a motor comprising a gearbox with magnetic planets.

FIG. 2 is a simplified schematic axial end view of the portion of a motor of FIG. 1, also showing electromagnetic stator poles/posts represented by dashed lines.

FIG. 3 is a schematic circumferential section view of the exemplary embodiment in FIG. 2 with a partially assembled stator on both axial ends of the planets.

FIG. 4 is a schematic cross section of an exemplary embodiment of a gearbox having larger outer planets than inner planets, with 16 planets per row, and the larger row of planets having magnets.

FIG. 5 is a schematic cross section of an exemplary embodiment of a gearbox having larger outer planets than inner planets, with 14 planets per row, and the larger row of planets having magnets.

FIG. 6 is a schematic cross section of an exemplary embodiment of a gearbox having larger outer planets than inner planets.

FIG. 7 is a schematic side view of two planets showing an exemplary gear pattern.

FIG. 8 is a diagram showing a simplified example of a low angle lobe profile.

FIG. 9 is a schematic cross section of an exemplary gearbox with hollow planets showing a path between an inner ring and an outer ring.

FIG. 10 is a front isometric view of an embodiment of a gearbox.

FIG. 11 is a rear isometric view of the gearbox of FIG. 10.

FIG. 12 is an isometric cutaway view of a gearbox with an asymmetric sun input.

FIG. 13 is an exploded view of the gearbox of FIG. 12.

FIG. 14 is a cutaway view of the gearbox of FIG. 12 showing exemplary assembly steps.

FIG. 15 is a schematic view of profile shift concepts that may be implemented for gear tooth profiles.

FIG. 16 is an isometric view of a testing system for a gearbox.

FIG. 17 is a cutaway view of an exemplary gearbox showing an idler ring.

FIG. 18 is an isometric view of an exemplary symmetric gearbox.

FIG. 19 is an isometric cutaway view of the symmetric gearbox of FIG. 14.

FIG. 20 is an isometric cutaway view of an exemplary gearbox with an asymmetric sun input.

FIGS. 21-22 are alternative views of a symmetric gearbox according to certain embodiments.

FIGS. 23-24 are alternative views of an alternative gearbox according to certain embodiments.

FIGS. 25-28 are alternative views of a gearbox in accordance with certain embodiments.

FIGS. 29-35 are alternative views of various components of a complete gearbox provided within a housing in accordance with certain embodiments.

FIGS. 36A-36C show schematically a portion of a gear formed respectively in a normal shape out of soft material, in a thin shape, and in a shape having cuts at the gear roots.

FIG. 37 is an isometric cutaway view of a two-stage gearbox.

FIG. 38 is an isometric cutaway view of an actuator including the two stage gearbox of FIG. 37.

FIG. 39 is a side section view of the actuator of FIG. 38.

FIG. 40 is a schematic side section view of a gearbox having tapered planets.

FIG. 41 is an exploded isometric view of a gearbox having tapered planets.

FIG. 42 is a side section view of the gearbox of FIG. 41.

FIG. 43 is an isometric view of the gearbox of FIG. 41.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Immaterial modifications may be made to the embodiments described here without departing from what is covered by the claims. Rather, these embodiments are provided so that this disclosure will satisfy applicable legal requirements. Like numbers refer to like elements throughout.

Embodiments of the present device eliminate the need for a planet carrier by transmitting torque from an inner fixed ring to an outer output ring directly through two rows of planets. The gear reduction ratio is determined by the difference between the OD of the inner ring and the ID of the outer ring with the inner and outer planets acting as a torque transfer load path between them. As the planets are caused to orbit, the outer ring will rotate at a ratio such as approximately 3:1 or possibly lower, or up to approximately 6:1 or possibly higher. The closer the OD of the inner ring is to the ID of the outer output ring, the greater the reduction ratio.

Embodiments of the device disclosed here use a combination of features to provide equal circumferential spacing as well as axial alignment of the planets and races as well as eliminating the need for additional bearings in some applications or reducing the strength (and therefore the cost and weight) of the additional bearings by virtue of the interaction of the planets and races providing axial alignment from the inner race to the outer race. Furthermore, embodiments of the device disclosed here provide a structure that applies a magnetic force directly to the planets to eliminate the need for a separate motor rotor where the planets themselves act as the rotor with a reduction ratio because they are orbiting at a higher speed than the output ring. This eliminates the need for a sun ring input which simplifies the manufacturing and assembly of the motor-gearbox combination. The fact that the planets (and therefore the contained magnets) are spinning is not believed to be a significant detriment because they are still providing magnetic flux to the airgap and stator.

Embodiments of the device use gears or lobes that are small enough and numerous enough to provide what acts and feels more like a rolling contact than a gear. In the claims, the term “lobes” also encompasses the term “gears”. Lobes have the advantage of providing a high surface area in the radial direction (as opposed to a gear that has gear teeth which act like wedges). In an example, the pressure angle of the lobes or gears may be greater than 20, 30 or 40 degrees. In an alternate configuration, high angled gears can be used instead of lobes. By configuring the gears or lobes in a herringbone configuration, a number of characteristics can be achieved, including: circumferential planet spacing as a result of the gear-specified circumferential positioning of the planets; axial alignment of planets to races and inner planets to outer planets as a result of the herringbone helical gears; and the ability to eliminate or reduce the need for a bearing between the inner and outer races because the herringbone gears on the planets provide multi-axis (i.e., radial and axial location) constraints. The use of permanent magnets (PMs) in the planets allows one or more (e.g., two) electromagnetic stators positioned on axial ends of the device to be commutated in such a way as to impart rotational torque and motion to the planets, and by doing so to generate torque on the outer ring (using the inner ring as a fixed reference in these non-limiting examples, although it is understood that the outer ring can be used as the fixed reference and the inner ring can be the output ring. It is also understood that the stator(s) can be attached to the inner or outer ring regardless of which one is fixed and which one is the output).

### Embodiments Including Permanent Magnets

A typical conventional differential gear with a planet carrier cannot include PMs in the planets because the differential gearbox requires bearings and shafts in the planets. Furthermore, if a conventional planetary gear (with a single circular array of planets) uses PMs in the planets together with a fixed sun gear it will act as a speed increaser rather than as a reducer.

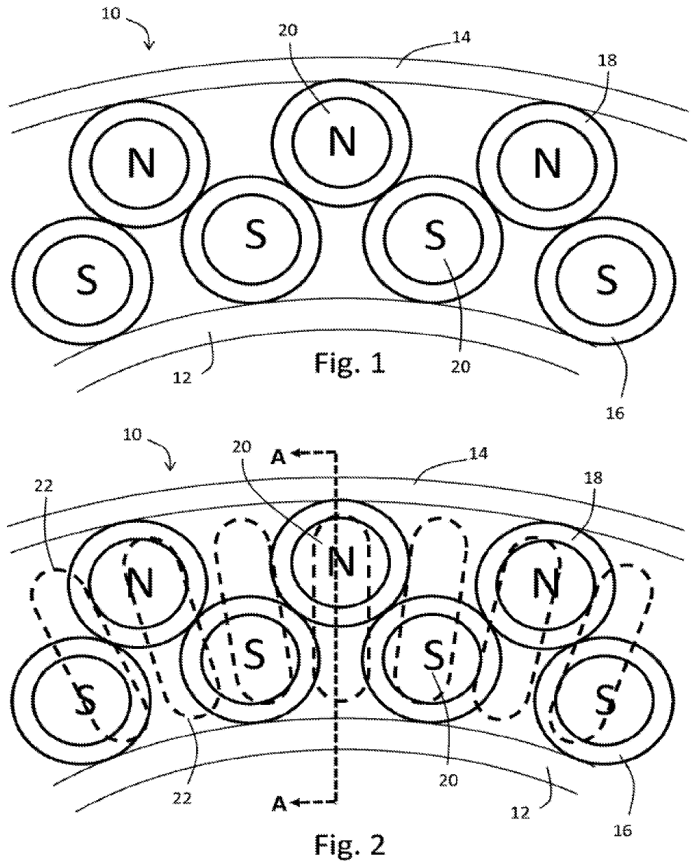

In FIG. 1, a simplified schematic is shown of a section of a non-limiting exemplary embodiment of the device 10. An inner race 12 acts as a fixed or reference race, an outer race 14 acts as an output member, and respective arrays of inner planets 16 and outer planets 18 impart torque from the inner race 12 to the outer race 14 when they orbit. In order to cause the planets to orbit, embodiments of the device have a permanent magnet 20 embedded in (e.g., placed within an axial interior opening of) one or more of the planets and preferably, as shown in FIG. 1, all of the inner and outer planets.

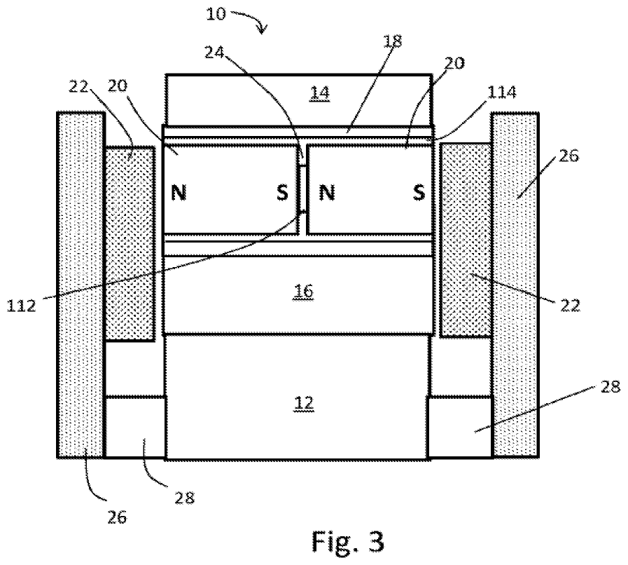

FIG. 2 shows a simplified schematic view of an embodiment of the device 10 with electromagnetic stator poles/posts 22 represented by dashed lines. A range of numbers of planets and posts can be used such as could be used in a conventional electric motor and stator such as 72 stator posts and 68 planets. The number of planets in this non-limiting example includes 34 inner planets and 34 outer planets. The stator may have electromagnets with posts or air coils. Also shown in FIG. 2 is a section line A-A showing where the cross section view of FIG. 3 is cut. The section line cuts through an outer planet but between inner planets. If air coils are used, it is preferable to have a soft magnetic material backiron 26 to carry flux from each air coil 22 to each adjacent air coil 22.

FIG. 3 shows a schematic cross section of the non-limiting exemplary embodiment in FIG. 2 with a partially assembled stator on both axial ends of the planets. (Coils on electromagnetic elements are not shown). The placement of the permanent magnets 20 is such that two magnets are used and placed in the outer planets 18 from either end such that they pull together across a separating or axially locating member 24. This allows the magnets to be held in the planets without the need for additional securing means. This provides the full end of the magnet for propulsive force when interacting with the electromagnetic stator poles 22. Other means of inserting and securing the magnets may also be used. The inner planets may use the same or different arrangement as the outer planets. Stator elements including poles (embodied as air coils in the illustrated embodiment) 22 and backiron 26 are shown schematically. As shown, the stator elements may be on both axial sides of the device 10. The stator may be attached to a fixed element, here the inner race 12. Here, spacers 28 are used to connect the backiron 26 to the inner race 12.

The axially locating member 24 need not separate the magnets. The member 24 merely prevents the magnets from moving together. If separated, such as with two simple cylindrical PMs that are separated by a ring of plastic (if plastic gears are used) to form axially locating member 24, then there needs to be a soft magnetic material disk 112 (e.g., steel) between them.

The axially locating member 24 is preferably molded or fabricated as one piece with at least an inner portion 114 (inner diameter) of the planets. The entire planet can be formed as a single piece, or the gear faces of the planet may be one or more separate pieces into which the inner portion 114 is inserted. A soft magnetic member, such as a steel disk 112, is preferably used as a flux linkage path between the two magnets. In certain embodiments, the PMs may have a smaller diameter cylindrical end section instead of the soft magnetic material disk. Simple cylindrical magnets are considered to be less expensive to build, and the use of a steel disk spacer for flux linkage between them allows this disk to be easily adjusted to the ideal thickness (whereas PMs are more difficult to machine to the same tolerance).

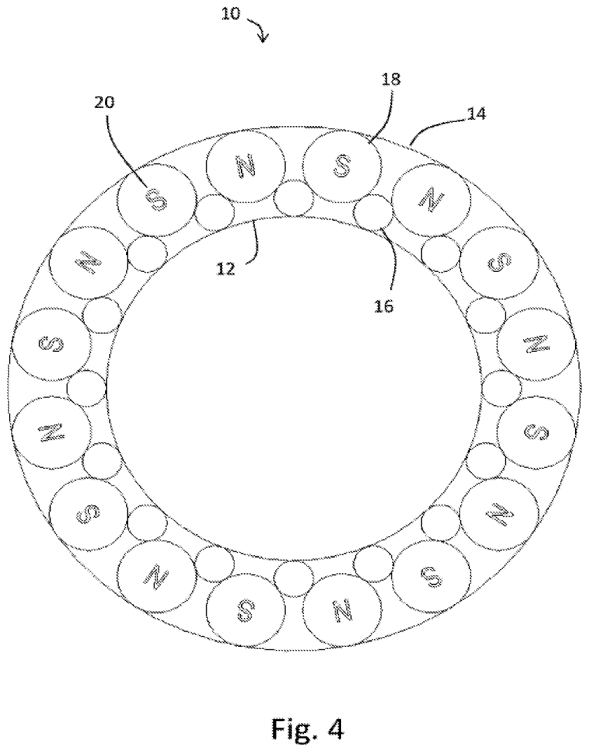

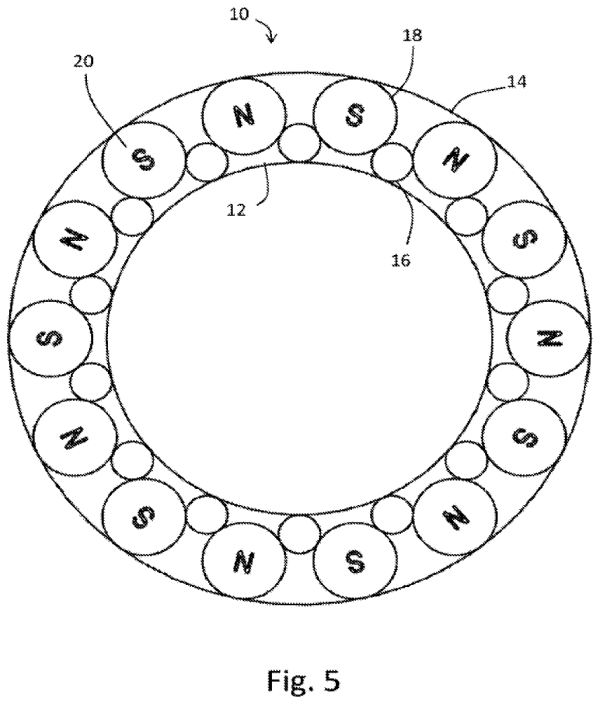

The embodiment shown in FIGS. 1-3 has 2 rows of planets (rollers, planetary gears, and/or the like) of similar size, with magnets in the planets of each row. The magnets are oriented to have a first polarity arrangement (as viewed from one axial side), such as a North (N) pole in one array and a second polarity arrangement, such as a South (S) pole in the other array, as seen in FIGS. 1 and 2. Some configurations use one array of planets that are much smaller than the other. In such embodiments, magnets may be located in only the larger planets (and not in the smaller planets), however it should be understood that magnets may be placed in other planet orientations in various embodiments. Placement of magnets only in the larger planets provides benefits such as providing a lighter stator due to smaller radial dimension. The magnets can be restricted to one row regardless of the planet sizes. An example, shown in versions with 16 and 14 planet per row respectively in FIGS. 4-5, has larger outer planets 18 with magnets 20 only in the outer array.

This single row of magnets configuration has alternating polarities of the magnets in a single array of PM planets.

The stator may have a plurality of poles. Each pole may be embodied as, for example, an electromagnet having a post, or an air coil. For a conventional three phase motor, the stator has a number of poles divisible by 3 (the term “poles” or “posts” when referring to the stator, refers to each individual post and coil, or coil, if air coils are used). It can also be useful to have the number of poles divisible by 4, so if the number of poles is both divisible by 3 and divisible by 4, the number of poles is divisible by 12.

The number of rotor posts (rotor posts, here, refers to the number of planets with permanent magnets of alternating polarity relative to adjacent planets with magnets) is then based on the number of stator posts and, for a concentrated winding, the number of rotor posts is greater than or lesser than the number of stator posts. For example −2 or +2, but −4 or +4 is preferred, because this distributes the magnetic force around the air gap to reduce the bending load on the stator. Other differences will work also.

Here, the number of rotor posts is the number of planets with magnets in them, which is typically either the number of total planets or the number of planets in one of the rows of planets.

An example of a suitable number of planets in a row, in an embodiment with magnets in one row of planets, is 16, as shown in FIG. 4.

The embodiments shown in FIGS. 1-5 are referred to here as sunless self-energizing gearboxes. These embodiments each have only one (typically fixed) inner ring and one outer ring (typically connected to an output). The planets act as bearings, reducing or eliminating the need for conventional bearings. Such an actuator may be usable for implementations that utilize a high speed actuation, such as an exoskeleton. Embodiments disclosed in this application could be used for example in an exoskeleton as disclosed in US patent application publication no. 2017/0181916, the contents of which are incorporated herein by reference in their entirety.

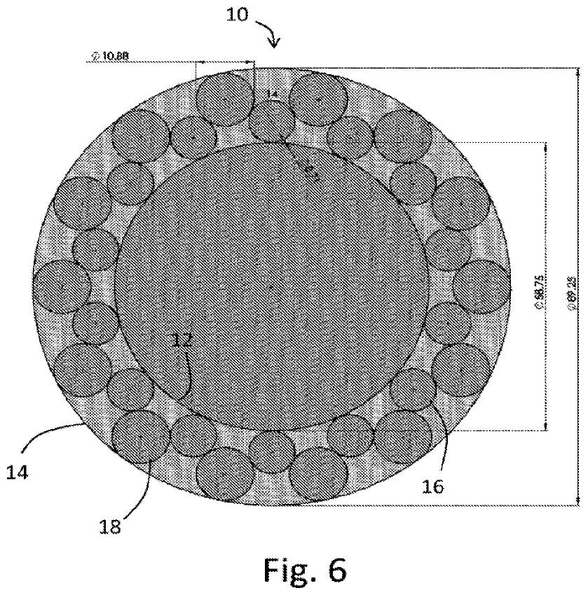

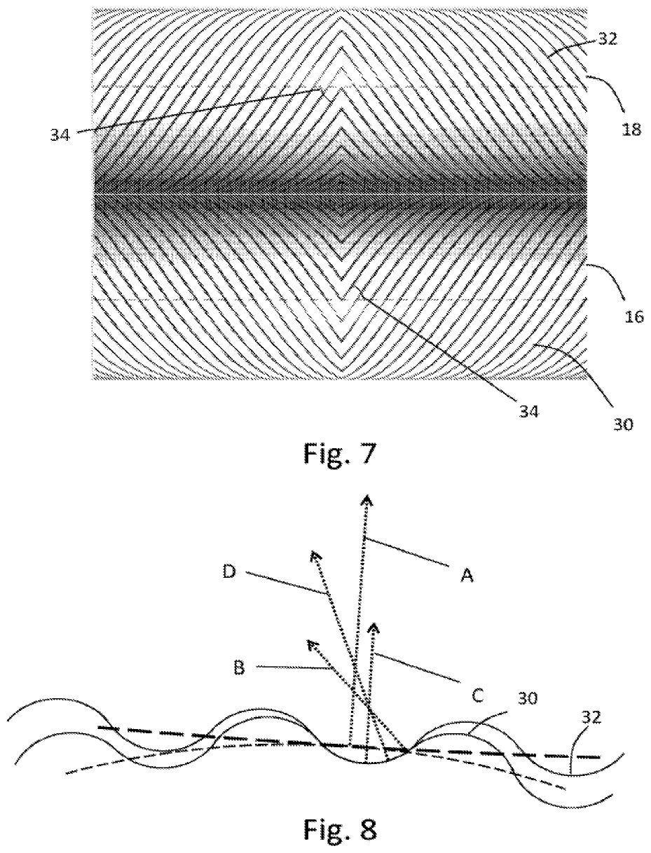

FIG. 6 shows an embodiment with 14 planets per row, with a less extreme difference in planet sizes than in FIG. 5. No magnets are shown. All of these embodiments can be used with or without magnets. Without magnets, input forces/torques may be supplied by an external source, such as an input gear powered by an external motor as described and shown below.

### Gear or Lobe Configurations

FIG. 7 shows a non-limiting example of inner herringbone gears or lobes 30 on inner planet 16 and outer herringbone gears or lobes 32 on outer planet 18. The gears or lobes 30 and 32 are shown schematically by lines. The gears or lobes 30 and 32 would mesh, though in this figure the gears appear slightly separated. The herringbone gears or lobes help constrain axial positioning of the planets. The axial positioning may be constrained by any use of gears or lobes that have a different helix angle at different portions of a planet simultaneously in contact with a surface or another planet. The herringbone shape shown in FIG. 7 is only one example of this. To distinguish from the “pressure angle” defined below, the angle referred to in this paragraph, being an angle of the lobe peaks or troughs away from an axial direction, will be referred to as a helix angle. The helix angle 34 (represented by an arc connecting a line showing a lobe 30 to a dotted line parallel to the axis of the inner planet 16) is opposite on different axial portions of the planets in this embodiment. This opposite, non-zero angle is an example of different helix angles on different axial portions.

Although this device could possibly be configured to work with traction surfaces, the use of lobes as for example shown in FIG. 8 will have the effect of increasing the apparent coefficient of friction by preventing sliding at higher angles between the gears. A high effective pressure angle lobe can therefore be used such as a sine wave profile as long as the average maximum pressure angle when under load is low enough to prevent the lobes or gear faces from disengaging.

The pressure angle of certain device 10 embodiments can significantly affect the loading of the gears/lobes 30, 32. Because there is a self-camming action (as discussed herein) when the device 10 (gearbox) is loaded and designed in accordance with certain embodiments places a radial load on the planets 16, 18. With a pressure angle below a lower threshold, there is risk that the gear teeth bind, such that the device 10 does not rotate or produces high friction. With a pressure angle above an upper threshold, the gears/lobes 30, 32 become too shallow to take significant load, which may result in skipping of the gears/lobes 30, 32 under load. The lower threshold and upper threshold are affected by the camming angle of the inner and outer planets 16, 18.

Adjusting the pressure angle may increase or decrease radial forces in order to improve load sharing among the plurality of planets 16, 18 or to increase the longevity of the planets 16, 18 or other gears in a device 10 (e.g., by decreasing the loads experienced by the gears). For example, in a device 10 incorporating planets having a low stiffness (e.g., comprising a low-stiffness material or a low-stiffness configuration), the material stiffness alone provides a significant amount of deflection to allow for load sharing between the planets 16, 18 or the device 10. Providing gears/lobes 30, 32 having a high pressure angle would increase the radial load on the planets 16, 18, but decrease the bending load on the planets 16, 18. Such a configuration may increase the longevity of the planets 16, 18 in implementations in which tooth root bending is identified as a critical failure mode. More typically, one would want to decrease the radial load on the less-stiff planets 16, 18 and make use of a lower pressure angle of the gears/lobes 30, 32 to maximize the overall stiffness of the device 10. In a device 10 having high stiffness planets 16, 18, additional radial load may be utilized to ensure there is enough deflection of the planets 16, 18 (or other gears/rings as discussed herein) to ensure load sharing between the planets 16, 18. As an example, utilizing a higher pressure angle may provide sufficient deflection of the planets 16, 18 to increase load sharing among the planets 16, 18.

It may be beneficial to have a higher pressure angle for the planets 16, 18 due to the decreased stress concentration at the tooth root. This would translate to a lower stress in the tooth root, which may increase the longevity of the planets 16, 18.

A simplified example of a high effective pressure angle lobe profile is shown in FIG. 8. A high effective pressure angle lobe geometry is believed to allow a high rolling contact capability by increasing the radially active surface area. The combination of the self-camming effect that increases the radial contact force with increased torque and this low effective pressure angle lobe geometry is expected to result in minimal sliding and therefore low rolling friction.

High effective pressure angle—In a conventional gearbox, a high pressure angle would result in a high separating force between the gears during torque transfer. In embodiments of the device, the lobe pressure angle is low enough to increase the effective friction coefficient of the contact areas so a camming angle is established. Once this critical effective friction coefficient (EFC) is established, the self-energizing effect will cause the planets to increase the traction pressure rather than to slide or skip. FIG. 8 depicts lobe contact between a planet and race. The dashed curves represent the pitch diameter of a planet on the bottom and a larger diameter race on top. The long, dashed line A represents the actual contact angle if the contact between the planet and race were a non-geared interface, and the contact angle under such an implementation is in the radial direction relative to the axis of the planet. Line B represents the maximum pressure angle during the lobe mesh as the planet (having lobes 30 as shown) rolls on the race (having corresponding lobes 32 as shown) and is normal to the surface of the lobe. Line C represents the minimum pressure angle during the load mesh as the planet (having lobes 30 as shown) rolls on the race (having corresponding lobes 32 as shown) and is normal to the surface of the lobes 30. During torque transfer, the contact pressure is biased in one direction so there is no effective contact in the opposite direction of contact line B. As a result of this contact pattern, the average effective pressure angle is along line D, approximately halfway between lines B and C.

As described in WO2013173928A1 (the content of which is incorporated by reference herein), each of the inner race and outer race may be circular and centered on an axis. A traction angle øᵢ may be defined as follows: for each pair of a first inner planet 16 that contacts a first outer planet 18, the traction angle øᵢ is defined as the angle between a first line extending outward from the axis through a center of the first inner planet 16 and a second line extending from the contact point of the first outer planet 18 with the outer race 14 and a contact point of the first inner planet 16 with the inner race 12. Orbital motion the planets 16, 18 leads to differential motion between the inner race 12 and outer race 14, and thus torque forces are transmitted between the inner race 12 and outer race 14 via the planets 16, 18. The torque forces are transmitted between the contact points of adjacent planets 16, 18 and thus are transmitted at the traction angle having a ratio of a circumferential component to a radial component equal to the tangent of the traction angle øᵢ. Thus, as described in WO2013173928A1, for traction surfaces if a coefficient of friction between the inner race 12 and inner planet 16 is greater than the tangent of the angle, the torque will generate a radial component sufficient to maintain traction between the inner planet 16 and the outer planet 18 as the torque increases, without requiring a large preload or any additional mechanism to increase radial loading. This is referred to herein as the “camming effect”; a device 10 exhibiting this camming effect may also be referred to herein as “self energizing” (e.g., a self-energizing gearbox).

With gears or lobes 30, 32 on the planets 16, 18, the coefficient of friction between the surfaces of the planets 16, 18 is not relied on to create a self-energizing effect to keep the planets 16, 18 from rotationally sliding on each other. Instead, the gears or lobes 30, 32 serve to time the planets 16, 18 to each other and to their respective races.

In an embodiment shown in FIG. 7, the lobes 30, 32 cover substantially a full radial surface of the planets 16, 18, and the inner planet lobes 30 mesh with both outer planet lobes 32 and inner race 12 lobes, and the outer planet lobes 32 mesh with both inner planet lobes 30 and outer race 14 lobes. However, certain embodiments may have lobes only on a portion of the planets 16, 18. Also, other embodiments may provide a different portion of the planets 16, 18, and thus possibly different lobes 30, 32, in contact with the corresponding race than with the adjacent planets. One could also have different selections of lobes, gears, or traction surfaces for the different contacts.

### Gear Tooth Profile

Embodiments of the present device 10 incorporate a geared contact between the two rows of planets 16, 18 and between planets and races. This geared contact allows a larger camming angle and potentially higher torque transmission. One challenge to be solved with a geared contact is that the radial compression between geared components can result in non-conjugate motion, and high friction and cogging as a result of the wedging effect of teeth of one planet acting as wedges that are being forced between the receiving teeth of the meshing planet. This wedging effect results in a high mechanical advantage of the radial force between the planets planar to the gear contact faces resulting in high friction and wear. Forcing gears together radially will also result in a variable friction force as the mechanical advantage changes throughout different phases of the gear tooth contact during planet rotation. This variable friction force can result in cogging and irregular wear.

A new gear tooth profile for the device provides a combination of rolling contact at a coefficient of traction, combined with an involute gear tooth profile that provides the rest of the torque transfer not provided by the rolling contact.

The use of a cylindrical rolling contact surface between the gear teeth and if used with spur gears, will reduce the amount of geared contact (i.e., it will reduce the contact ratio). At a high enough percentage of cylindrical rolling contact, a geared contact ratio of less than 1 will occur. Up to this ratio, it is difficult or impossible to achieve a rolling contact ratio of greater than 1. The use of a helical tooth pattern as described here, can provide a continuous rolling contact between gears as well as a continuous geared contact for smooth rolling contact and uninterrupted geared torque transmission. Helical teeth having helical direction at different axial portions of planets can form herringbone teeth.

It should be noted that embodiments may use a camming angle and coefficient of friction that allows the rolling surfaces to transmit a high percentage of the torque. In other applications, it may be preferable to use a camming angle and CF which does not result in a self-energizing effect. In this case the gear teeth may provide a greater percentage of the total torque.

### Lobed Gears

Reasonable performance has been shown with a relatively simple gear tooth profile that uses a sine wave shape gear form. This shape can be a pure sine wave or an approximate sine wave such as a series of linked arcs which form lobes. With a high enough number of lobes, the height of the teeth is short enough to reduce the sliding motion between the gear teeth while providing enough surface area at the tips and roots of the lobes in the radial direction for smooth rolling contact. For example, the lobe height may be less than 1/20, 1/30 or 1/40 of a radius of a gear, for example an inner planet gear 16 or outer planet gear 18. The use of a high helix angle provides a consistent radial contact and consistent torque transmission surface area in the tangential direction. When this lobed shape is used with the self camming geometry of the present device 10, the traction angle will determine how much of the torque transmission is provided by the tangential contact and how much is provided via traction of the tooth roots in semi-rolling contact with the tooth tips.

### Torque Transmission

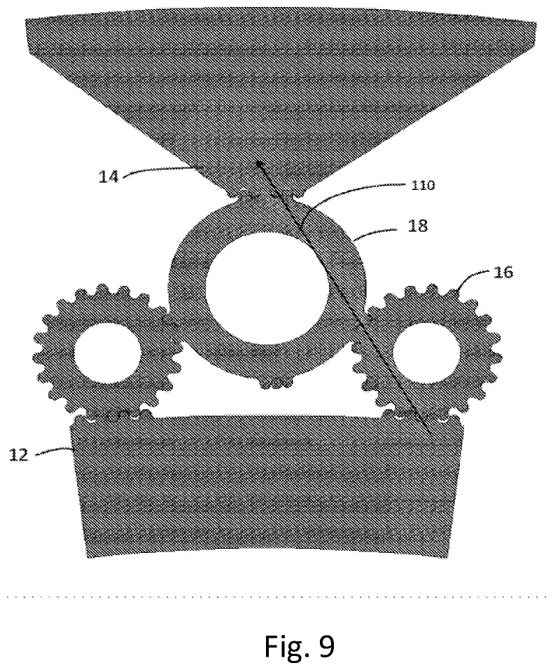

Embodiment of the device 10 provide rigid torque transmission, even when constructed from plastic. The rotational stiffness potential of embodiments of the device 10 are believed to be much higher than is possible from a conventional planetary gear train. This is because the torque is transferred from the inner gear 16 to the outer gear 18 along a nearly straight line though the inner planets 16 and outer planets 18. This straight line torque transfer is shown in a simplified FEA analysis in FIG. 9. An arrow is added to mark the line of stress 110 which is shown as lighter shading in FIG. 9.

Increased radial preload may increase stiffness, but also increase rolling friction. Increased rolling friction is not always beneficial, but there are cases where increased rolling friction may be helpful. In machining, for example, it is desirable to prevent backdriving of the gearbox as a result of tool load or vibration. In other uses, like applications where a safety brake is needed, high preload can be used to make the gearbox non-backdriveable below a certain backdrive torque. This reduces the cost and complexity and power consumption of a brake which must be disengaged with an electric current, for example.

### Embodiment with Input Ring

In one example, a self-energizing portion of a device comprises a stationary inner sun gear meshing with a plurality of spaced inner planets 16 (e.g., 17 equally spaced inner planets 16), which in turn mesh with a corresponding number of spaced outer planets 18 (e.g., 17 equally spaced outer planets 18). The outer planets 18 then mesh with a race of the outer ring. The input of this stage is the orbit of the planets 16, 18, while the output is the motion of the outer ring. The input stage drives the planets 16,18 in the self-energizing stage by using a planetary gear. This stage uses the sun gear as an input, the planet rotation as the output, and an idler outer ring. In an example embodiment, a 45° helix angle is used in a herringbone configuration for each of the gears, however other helix angles (whether provided in a herringbone configuration, a continuous helix configuration, a changing helix-angle configuration, a spur-gear configuration, and/or the like).

The diameters and number of gear teeth used in the embodiment having a 45° helix angle is embodiment are shown in Table 1.

TABLE 1

| | Diameter | # of Teeth |
|---|---|---|
| Sun | 105.4 | 170 |
| Inner Planet | 19.85 | 32 |
| Outer Planet | 12.40 | 20 |
| Outer Ring | 158.10 | 255 |
| Input Sun | 124.89 | 102 |
| Input Planet | 20.81 | 17 |
| Idler Ring | 166.51 | 136 |

Traction and geared configs of embodiments of the device are described in published patent application no. WO2013173928A1. Various embodiments as discussed herein include configurations using geared input and gear tooth profiles and configurations to provides benefits which include effective ways to keep planets equally spaced (circumferentially and axially), ways of minimizing part count through a non-symmetric input, and a simplified way of increasing reduction ratio though a non-symmetric sun ring input to the inner or outer planet arrays.

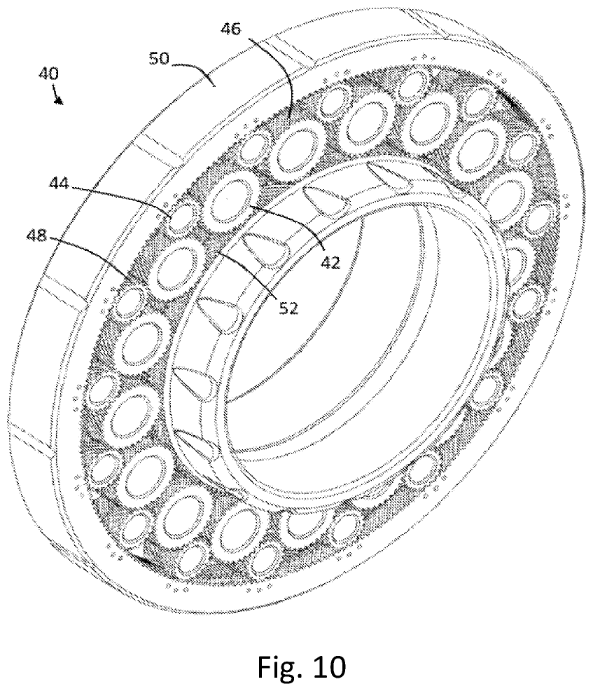

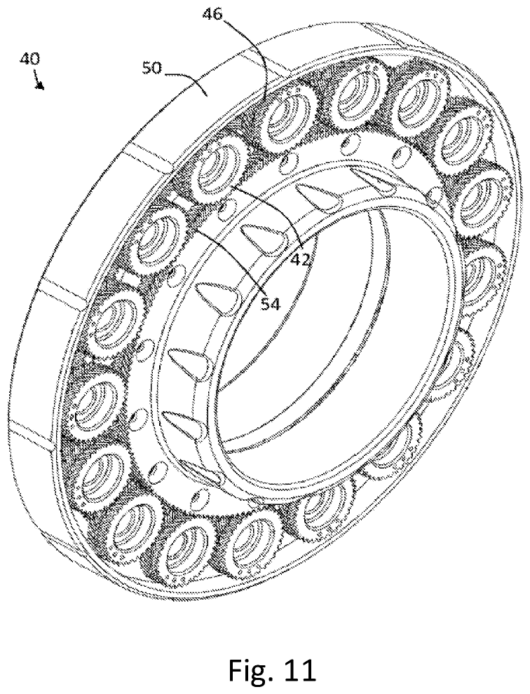

FIGS. 10 and 11 show respectively front and rear isometric views of an embodiment of a gearbox 40. As can be seen, there are inner gears 42 and outer gears 44 with herringbone shaped gear teeth 46 on the inner gears 42 and meshing herringbone shaped gear teeth 48 on the outer gears. Only the inner gears 42 extend to the rear of the gearbox in this embodiment. An outer race 50 drives the planetary gears, the inner gears 42 contacting different sized inner races 52 and 54 to drive one inner race 52 with respect to the other inner race 54.

### Axially Outward Sun Gear Input

The use of geared contact between the planets and ring gears keeps them equally spaced circumferentially. Moreover, in accordance with certain embodiments, the use of herringbone gear or lobe teeth prevents movement of the gears in the axial direction. This allows the gears to be used as a bearing for relative location of the inner fixed gear and the outer output gear in both the radial direction and the axial (thrust bearing) direction.

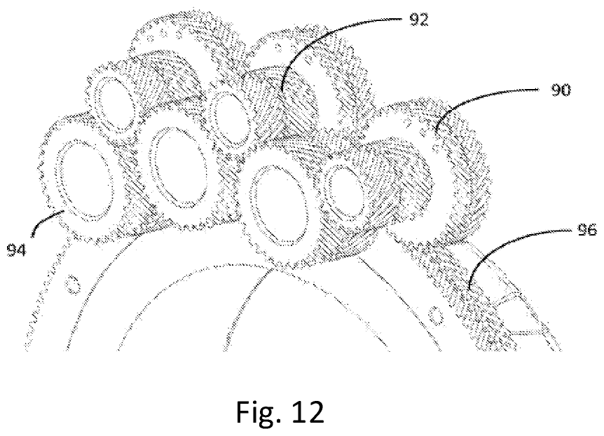

Moreover, this combination of herringbone gears or lobes provides the ability to drive the inner or outer planets from only one side of the gearbox without significant twisting of the planets about a radial axis of the device 10. By using a gear 90 in FIG. 12 which is fixed to the outer planet 92 (as shown here in this partial assembly sketch) or to an inner planet 94 of the same or different pitch diameter as the planet it is fixed to, the reduction (or speed increasing if in reverse) ratio can be increased through the use of a sun gear 96 input. This one-sided drive is also beneficial for assembly because it allows the use of a single gear array instead of two or more arrays aligned helically. These helical gears must be threaded together during assembly, so having only one set of planets in the axial direction allows the inner fixed ring gear and/or the outer output gear to be manufactured in two pieces and threaded together from opposing axial ends of the device 10.

In an example of how a non-limiting exemplary embodiment of the device can be assembled, the following describes one way the device can be assembled if the geometry is created according to the principles described here.

### Assembly

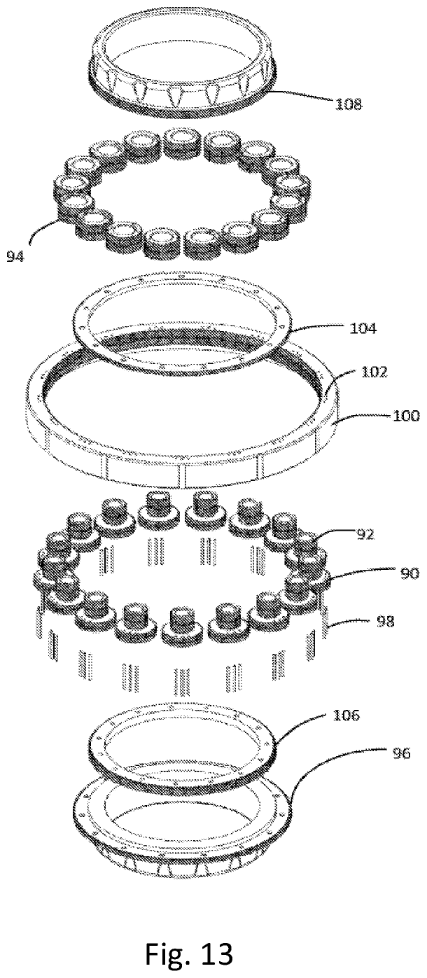

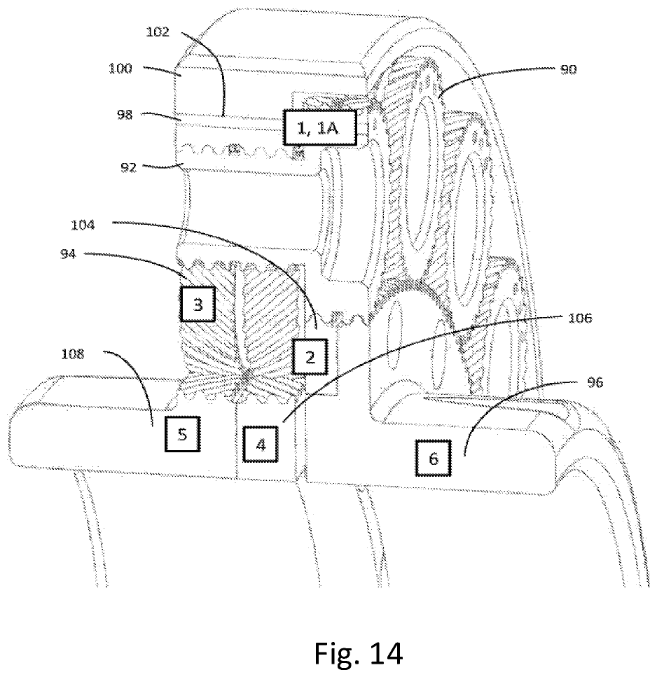

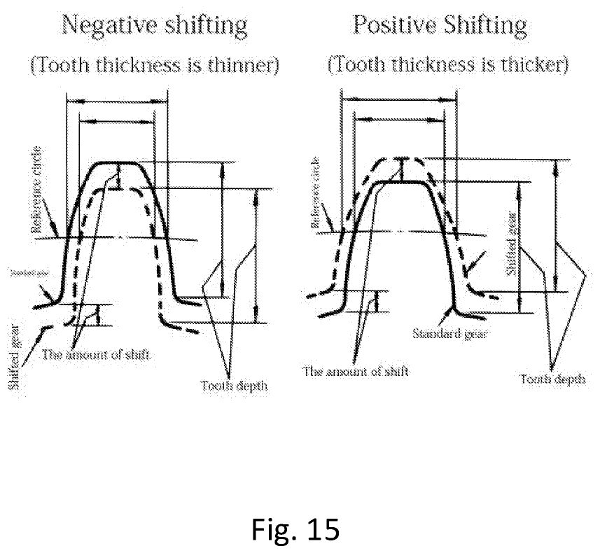

FIG. 13 is an exploded view and FIG. 14 a cutaway view of the device of FIG. 12. The parts indicated in FIG. 12 are also present in FIG. 13. In addition, there are pins 98 for temporary alignment of the outer planets; an outer output gear 100 having holes 102 for receiving the pins; an input sun ring 104 that combines with the input sun gear 96, and a stationary sun ring 106 that combines with a stationary sun gear 108.

Order of assembly is as follows, and indicated by boxes with step numbers in FIG. 14. In step 1, the outer planets 92 are inserted into the outer output gear 100. As they are the first components to be installed, there is sufficient space in the radial direction to place the outer planets 92 into the outer output gear 100 via a radial motion so the outer output gear and outer planets can each be constructed as single-piece components despite the herringbone meshing. In step 1A, pins 98 are inserted through holes in the outer planets 92 and holes 102 in the outer output gear 100. These pins are for temporary alignment and may be removed when no longer needed. In step 2, input sun ring 104 is inserted and meshes with first halves of the gears 90 fixed to the outer planet gears 92. In step 3, the inner planets 94 are installed. They also can be inserted radially. In step 4, the stationary sun ring 106 is installed and meshes with portions of the inner planet gears 94. In step 5, the stationary sun gear 108 is inserted and meshes with other portions of the inner planet gears 94. The stationary sun ring 106 and stationary sun gear 108 may be fixed together. In step 6, the input sun gear 96 is inserted and may be fixed to the input sun ring 104.

To operate this non-limiting example embodiment, turning the sun gear and holding inner ring will cause outer ring to spin at a reduced ratio of approximately 7:1.

If the outer planets are driven by the sun gear, as shown here, input by a larger gear than the outer planet diameter as shown here, it is preferable to have the smallest dimension of the larger sun input ring gear larger than the OD of the fixed ring gears. In this way, assembly of the gearbox is enabled because the two halves of the inner fixed ring (4, 5) can be “threaded” together from either side of the inner row of planets after the inner sun gear ring member (2) is threaded onto the larger sun input planet gears from the inner plane outward as described above. Furthermore, if the OD of the inner fixed ring is smaller than one half of the sun input ring, the sun input ring gear assembly can be a herringbone profile so it requires no bearing. The inner half of the sun input ring can be “threaded” into engagement with the sun gear input planet gears from the inside of the assembly before the yellow inner planets are inserted, and then the other half of the sun gear herringbone can be threaded on from the outside bolted to the first half of the sun gear after the inner (yellow) row of planets has been inserted and the two halves of the inner fixed gear herringbone has been assembled from both axial ends.

This configuration would make the assembly fully constrained in the axial direction, however such a configuration does not necessarily balance the axial loads as seen on the planets since it not a symmetric herringbone arrangement.

In order to minimize the axial loads on the planets, one of three design constraints may be implemented:

In embodiments in which the helix angle of the gears is kept constant along the axial length of each gear, the gear mesh between the inner planets and stationary sun gear has a different length relative to the gear mesh between the inner planets and the stationary sun ring; and the gear mesh between the outer planet and the input sun gear has a different length relative to the gear mesh between the outer plant and the input sun ring. These lengths may be selected to reduce axial forces.

In embodiments in which the axial length is maintained as constant, the gear mesh between the inner planets and stationary sun gear has a different helix angle relative to the gear mesh between the inner planets and the stationary sun ring; and the gear mesh between the outer planet and the input sun gear has a different helix angle relative to the gear mesh between the outer planet and the input sun ring. These lengths may be selected to reduce axial forces.

In embodiments in which neither the helix angle or the axial length is maintained as constant, the gear mesh between the inner planets and stationary sun gear has a different length and helix angle relative to the gear mesh between the inner planets and the stationary sun ring; and the gear mesh between the outer planet and the input sun gear has a different length and helix angle relative to the gear mesh between the outer plant and the input sun ring. These lengths may be selected to reduce axial forces.

### Gear Combinations

While there are many potential benefits of this device 10, at this point it has been shown by the inventors that there are no known gear combinations that provide a perfect gear mesh. Each solution has some amount of error in one or more parameters such as the gear diameter, module, meshing contact, and/or the like.

Some gearing solutions have errors that would be less than the manufacturing tolerances of the individual gear parts. The number of solutions that have such a low error is limited though, and it is desirable to have additional solutions.

So far, over 100 million combinations of planet numbers and gear tooth numbers on planets and gear rings has been tested with no perfect solutions found. This has required that the possibilities be narrowed down to the least imperfect possibilities.

The constraints for selecting a usable combination include the following:

The diameter differential of the sun and the outer ring is large enough to provide a reduction ratio between the inner fixed ring and outer output ring of greater than 2:1 (2 orbits of the planet results in 1 or more rotations of the output ring). Planet numbers range from min of 5 to max of 30, although there are additional solutions beyond this range of planets.

A gear tooth pitch of greater than 0.7 mm (this is to allow manufacturing by common gear production methods including injection molding).

An outer ring OD of approximately 89.25 mm was set as constant, knowing that the gear diameters can be scaled to larger or smaller diameters as required. By the application. This diameter was selected as one that is of useful size for the robotics market.

Only non-perfect solutions have been found. The imperfection in the gear combinations shows up as either an imperfect alignment of the gear teeth or a mismatch in the module of the meshing gears. Typically, the inner row of planets will mesh well with the inner fixed gear, and the outer row of planets will mesh well with the outer output ring gear, but the inner planet teeth will be misaligned to the outer planet row gears. Some misalignment can be tolerated due to the compliance/flexibility of the materials (and the resulting compliance/flexibility of the constructed components) but the greater the misalignment, the lower the torque transmission capacity of the gearbox and the greater the friction due to interference between the gears.

The use of more, smaller teeth increases the number of potential options, but small gear teeth make manufacturing and assembly more difficult and small teeth may also reduce torque transmission in some cases.

The use of fewer planets increases the manufacturability of the planets, but more planets allows for a larger maximum torque assuming the load is shared between planets and provides additional solutions.

With all of these considerations taken into account, the number of usable combinations is surprisingly low. An inaccuracy index was used to compare the different options with the index indicating how misaligned the planet-to-planet mesh is for a given option.

The potentially usable configurations have been limited to those solutions with an RMS error factor of less than 0.0004 and are shown in the following table. Error factors higher than shown will be appropriate for certain applications. In addition, the shown configurations may be scaled geometrically while keeping the number of teeth constant.

The error factor reflected within the data shown in Table 2 below accounts for both angular error and diameter errors. The ratio given assumes that the input is the rotation of the input sun, with the inner ring held stationary and the outer ring as the output.

TABLE 2

| | Diameter (mm) | | | | | # Teeth | | |
|---|---|---|---|---|---|---|---|---|
| # | Outer | Outer | Input | Inner | Inner | Outer | Outer | Input |
| Planets | Ring | Planet | Sun | Planet | Ring | Ring | Planet | Sun |
| 10 | 89.250 | 13.845 | 61.560 | 14.083 | 42.236 | 361 | 56 | 249 |
| 10 | 89.250 | 13.425 | 62.400 | 14.658 | 41.975 | 359 | 54 | 251 |
| 16 | 89.250 | 10.282 | 68.685 | 5.336 | 69.544 | 217 | 25 | 167 |
| 11 | 89.250 | 13.328 | 62.594 | 9.526 | 55.270 | 375 | 56 | 263 |
| 7 | 89.250 | 23.100 | 43.050 | 11.557 | 28.617 | 340 | 88 | 164 |
| 12 | 89.250 | 5.667 | 77.917 | 18.193 | 52.478 | 378 | 24 | 330 |
| 10 | 89.250 | 13.000 | 63.250 | 15.240 | 41.711 | 357 | 52 | 253 |
| 7 | 89.250 | 22.709 | 43.833 | 12.154 | 28.257 | 338 | 86 | 166 |
| 11 | 89.250 | 12.921 | 63.408 | 10.056 | 55.087 | 373 | 54 | 265 |
| 7 | 89.250 | 22.905 | 43.440 | 11.855 | 20438 | 339 | 87 | 165 |
| 5 | 89.250 | 20.146 | 48.959 | 21.566 | 24.855 | 381 | 86 | 209 |
| 16 | 89.250 | 10.644 | 67.961 | 4.903 | 69.629 | 218 | 26 | 166 |
| 6 | 89.250 | 19.461 | 50.329 | 15.434 | 45.005 | 399 | 87 | 225 |
| 6 | 89.250 | 19.109 | 51.032 | 15.962 | 44.782 | 397 | 85 | 227 |
| 6 | 89.250 | 18.754 | 51.742 | 16.494 | 44.557 | 395 | 83 | 229 |
| 10 | 89.250 | 14.053 | 61.144 | 13.798 | 42.366 | 362 | 57 | 248 |
| 10 | 89.250 | 13.213 | 62.824 | 14.949 | 41.844 | 358 | 53 | 252 |
| 6 | 89.250 | 18.395 | 52.460 | 17.032 | 44.330 | 393 | 81 | 231 |
| 6 | 89.250 | 18.033 | 53.185 | 17.576 | 44.100 | 391 | 79 | 233 |
| 6 | 89.250 | 19.285 | 50.680 | 15.910 | 40.815 | 398 | 86 | 226 |
| 6 | 89.250 | 17.666 | 53.917 | 18.125 | 43.868 | 389 | 77 | 235 |
| 5 | 89.250 | 25.665 | 37.920 | 13.632 | 25.665 | 386 | 111 | 164 |
| 24 | 89.250 | 5.067 | 79.117 | 7.393 | 70.197 | 229 | 13 | 203 |
| 21 | 89.250 | 9.211 | 70.828 | 9.215 | 55.897 | 281 | 29 | 223 |
| 7 | 89.250 | 23.294 | 42.662 | 11.261 | 28.795 | 341 | 89 | 163 |

| | # Teeth | | | | | | Ratio | Ratio |
|---|---|---|---|---|---|---|---|---|
| # | Inner | Inner | Error | RMS | | Tooth | (Outer Ring | (Sun |
| Planets | Planet | Ring | Sum | Error | Phases | Width | Output) | Output) |
| 10 | 57 | 171 | 0.0008 | 0.0003 | 10 | 0.8 | 3.2 | 2.2 |
| 10 | 59 | 169 | 0.0008 | 0.0003 | 10 | 0.8 | 3.2 | 2.2 |
| 16 | 13 | 169 | 0.0088 | 0.0025 | 16 | 1.3 | 9.1 | 8.1 |
| 11 | 40 | 232 | 0.0010 | 0.0003 | 11 | 0.7 | 4.9 | 3.9 |
| 7 | 44 | 109 | 0.0010 | 0.0003 | 7 | 0.8 | 2.5 | 1.5 |
| 12 | 77 | 222 | 0.0010 | 0.0003 | 2 | 0.7 | 4.1 | 3.1 |
| 10 | 61 | 167 | 0.0011 | 0.0003 | 10 | 0.8 | 3.1 | 2.1 |
| 7 | 46 | 107 | 0.0010 | 0.0003 | 7 | 0.8 | 2.4 | 1.4 |
| 11 | 42 | 230 | 0.0011 | 0.0003 | 11 | 0.8 | 4.9 | 3.9 |
| 7 | 45 | 108 | 0.0012 | 0.0003 | 7 | 0.8 | 2.4 | 1.4 |
| 5 | 92 | 106 | 0.0011 | 0.0003 | 5 | 0.7 | 2.1 | 1.1 |
| 16 | 12 | 170 | 0.0081 | 0.0023 | 8 | 1.3 | 9.2 | 8.2 |
| 6 | 69 | 201 | 0.0007 | 0.0003 | 2 | 0.7 | 3.8 | 2.8 |
| 6 | 71 | 199 | 0.0007 | 0.0004 | 6 | 0.7 | 3.8 | 2.8 |
| 6 | 73 | 197 | 0.0007 | 0.0004 | 6 | 0.7 | 3.7 | 2.7 |
| 10 | 56 | 172 | 0.0012 | 0.0004 | 5 | 0.8 | 3.2 | 2.2 |
| 10 | 60 | 168 | 0.0012 | 0.0004 | 5 | 0.8 | 3.1 | 2.1 |
| 6 | 75 | 195 | 0.0007 | 0.0004 | 2 | 0.7 | 3.7 | 2.7 |
| 6 | 77 | 193 | 0.0007 | 0.0004 | 6 | 0.7 | 3.6 | 2.6 |
| 6 | 71 | 182 | 0.0012 | 0.0004 | 3 | 0.7 | 3.3 | 2.3 |
| 6 | 79 | 191 | 0.0008 | 0.0004 | 6 | 0.7 | 3.6 | 2.6 |
| 5 | 59 | 111 | 0.0013 | 0.0004 | 5 | 0.7 | 2.4 | 1.4 |
| 24 | 19 | 181 | 0.0067 | 0.0023 | 24 | 1.2 | 9.0 | 8.0 |
| 21 | 29 | 176 | 0.0012 | 0.0004 | 21 | 1.0 | 4.8 | 3.8 |
| 7 | 43 | 110 | 0.0013 | 0.0004 | 7 | 0.8 | 2.5 | 1.5 |

Selecting for gear/lobe teeth of at least 1 mm (which allows for manufacturing such as by 3D printing) and minimizing the error factor, a discovery analysis according to the algorithm produced only hundreds of positive options from several hundred million possibilities that were examined

Other less ideal options are shown.

Included in the gear combinations are gears that are both in phase and out of phase. Including out of phase gears significantly increases the number of solutions when compared to only in phase solutions. Additionally, the error factor tends to be lower in out of phase solutions. Out of phase refers to a configuration where a pinion meshes with a ring gear at a different phase of the gear tooth mesh as compared to another pinion meshing with the same ring gear, for a given rotational position of the output.

In certain embodiments, higher error factors can be accommodated to provide a functional gearbox having components that appropriately move relative to one another by providing gear teeth on various gear surfaces that are subject to a profile shift. Using concepts of profile shift, gears may be designed having an adjusted center distance between two meshing gears, having adjusted designs encompassing undercuts in a gear with too few teeth, and/or having an adjusted amount of sliding in a gear mesh. In such a case, the same tool can be used to manufacture the gear, but its placement with respect to the center axis of the gear is changed. This results in a slightly different tooth form as shown in FIG. 15.

By making use of profile shift, a higher error threshold can be used for generating gearbox solutions for a device as discussed herein, while maintaining functionality of the device, even with gearing combinations that may otherwise render the device nonfunctional.

Profile shift is also used to optimize efficiency in a gear mesh by adjusting the amount of sliding that occurs in the gear mesh. By minimizing specific sliding, each gear tooth will have the smallest amount of sliding in the mesh, increasing efficiency and minimizing potential issues with wear failures. Commonly, this will shift the profile of one gear in a pair inward (−x) while shifting the mating gear profile outward (+x). The sum of these shifts in most applications tends to be very near zero in order for the system as a whole to work well.

In devices of self-energizing gearboxes provided in accordance with embodiments as discussed herein, the sum of these shifts is related to the amount of error in the gearbox solution. However, the magnitude of the sum of the profile shifts of gears within designs may increase to accommodate increased error factors while providing a functional self-energizing gearbox. Accounting for included shifts, the gear mesh between adjacent gears maintains an optimum point for its specific sliding as in a typical gearbox. In embodiments as discussed herein, there are significantly more gear meshes as compared to a typical planetary gearbox having analogous dimensions, meaning that once the error is accounted for in profile shift, any additional shift in one gear will correspond to a complimentary shift in every other gear. As such, the gear meshes are not optimized for specific sliding individually, but as a whole. This has the added benefit of allowing the profile shift due to the error in the gear mesh be spread between multiple gear meshes.

In certain example embodiments, the planet gears may be provided with a positive profile shift to effectively increase the pressure angle of each included gear tooth and to reduce the stress concentration at the root of each tooth in order to increase the life of the planet gears.

### Test Stand

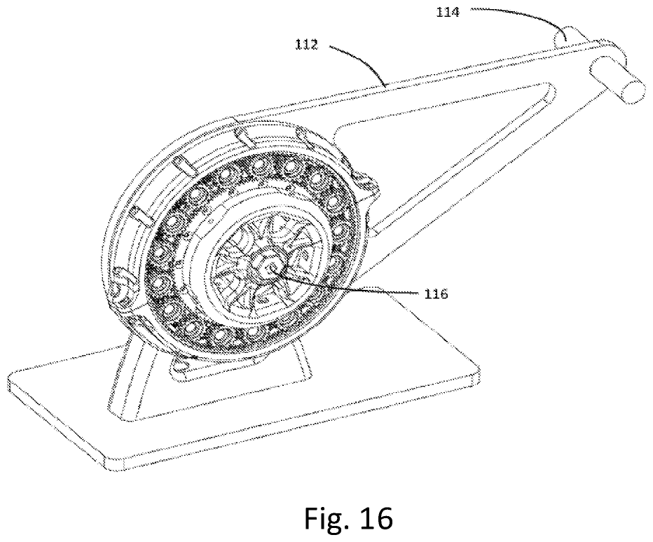

Separate components were designed and 3D printed to be fixed to the stationary and input components of the gearbox in order to test output torque capabilities. FIG. 16 shows a torque testing setup used to connect a mass on a lever arm to the gearbox and measure the required torque to lift the mass. As shown in FIG. 16, a 1 ft lever arm 112 was connected to the output outer ring to load the output of the gearbox and the output torque was calculated as the mass (not shown) attached to attachment point 114 multiplied by the length of the arm. A wrench (not shown) was attached to the input 116 of the arm for torque transfer through the device.

### Idler Ring

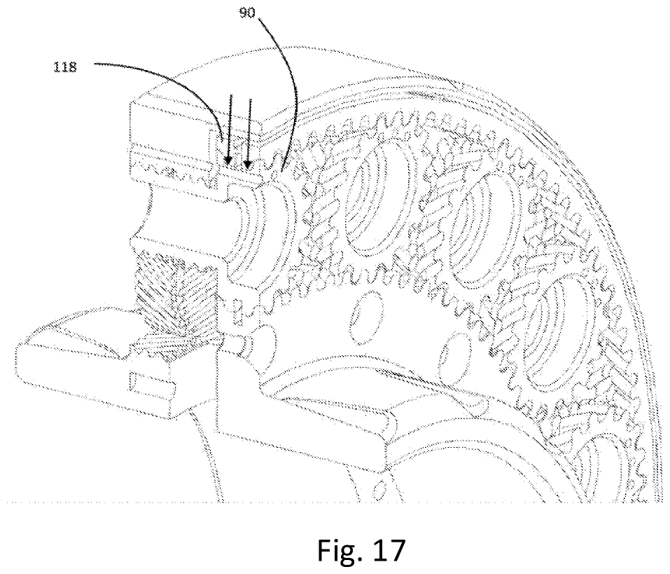

As shown in FIG. 17, an idler ring 118 around the larger diameter outer planet gear teeth on larger gear 90 can be inserted to prevent separation between planet gears and input sun gear teeth as gears are energized.

### Symmetric Configuration

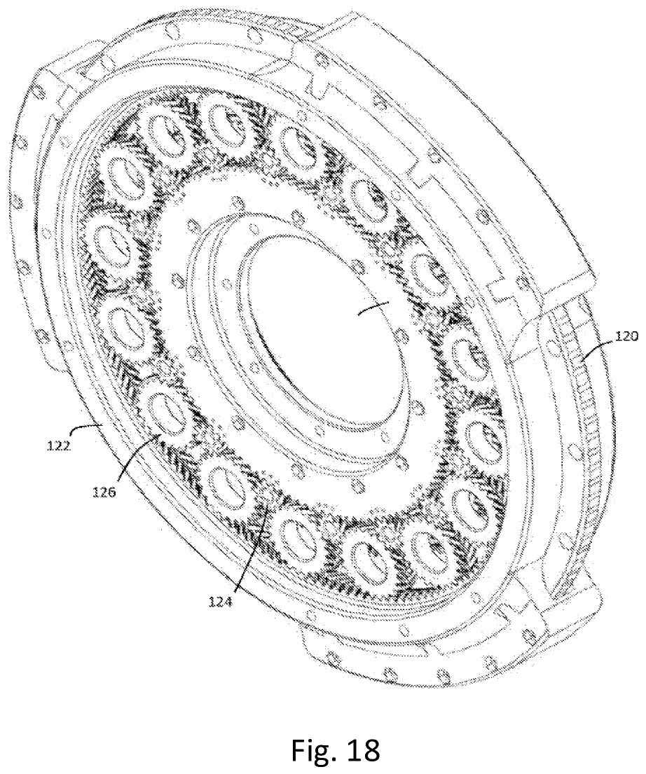

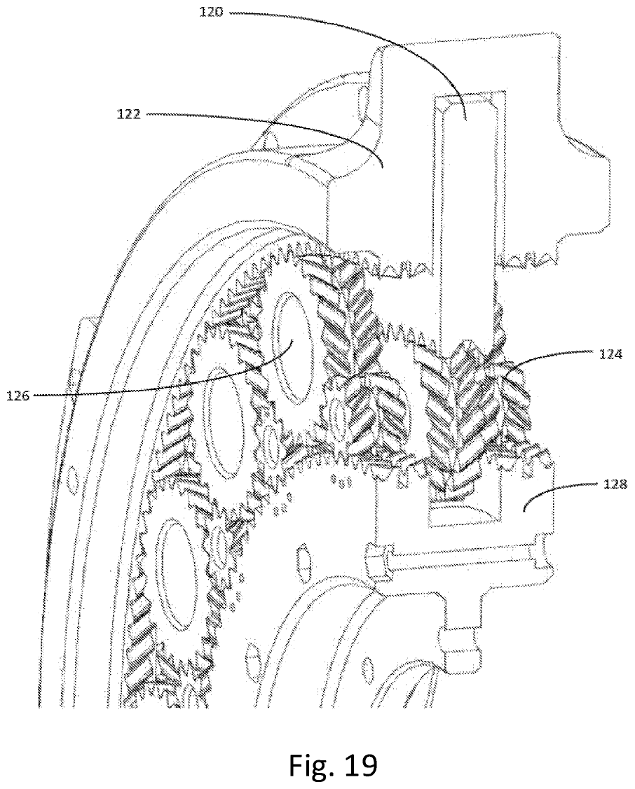

To prevent bending of the planets, the self-energizing gears can be positioned on either side of the input as shown in FIGS. 18 and 19. This configuration ensures that the planets stay parallel to the central axis of the gearbox. An outer input ring 120 is surrounded on both sides by stationary rings 122 and meshes with inner planet gears 124 to drive the inner planet gears 124. The inner planet gears 124 and outer planet gears 126 form a two row planet system to drive an output sun ring 128 relative to the stationary rings 122.

### Input Ring Meshing at Main Planet Diameter

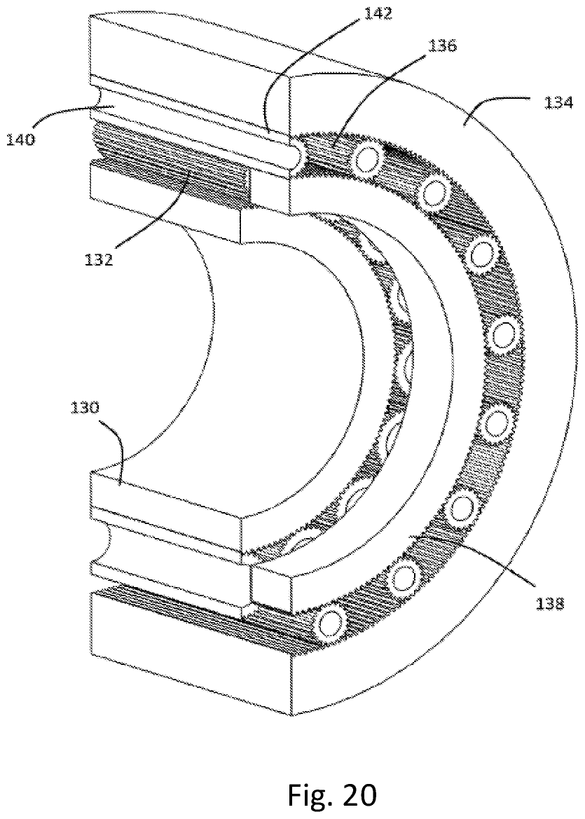

FIG. 20 shows a cutaway isometric view of a nonlimiting exemplary embodiment of a single-sided input self-energizing gearbox. An inner ring 130, here a fixed ring, is in contact with an array of geared inner planets 132. The outer ring 134, here an output ring, is also in geared contact with an array of geared outer planets 136, and each of the geared outer planets 136 is in contact with two geared inner planets 132. Input torque is supplied using a geared input ring 138. In the embodiment shown, the geared input ring 138 has a radially outward facing portion in geared contact with the outer planets. In this embodiment the outer planets 136 have the same diameter in a first portion 140 that meshes with the inner planets 132 and a second portion 142 that meshes with the input ring 138. Both the first portion 140 and second portion 142 mesh with the outer ring 134. Here the first and second portions include respective ends of the planet 136, but a symmetric arrangement such as shown in FIG. 19 could also be used. The engagement of the outer planets with the outer ring gear all the way along their length helps to keep the planets aligned. In the embodiment shown, a single gear mesh covers both first portion 140 and second portion 142, but these portions could also have separate gear meshes. The embodiment shown has straight cut gears but helical gears could also be used, as well as herringbone gears as described above. Helical gears in which all helixes on geared surfaces of the embodiments are the same enable the geared components to thread into assembly relative to one another. As discussed herein, axial forces are not generated in the same way as with a conventional planetary gearbox if helical gears are used.

In certain embodiments, a gearbox may have a single sided input, as well as a single helical tooth pattern (no herringbone pattern is necessary). The input drives the outer planets in this embodiment, and the planets cause a differential movement of the inner and outer rings, one of which is fixed and the other is the output.

Helical gears typically require thrust bearings or an opposing helix angle (herringbone pattern) to maintain axial positioning of the gears. However, these require space and weight. Embodiments as discussed herein encompassing helical gears that float axially have been found to demonstrate axial positioning stability during use. The inventors found that self-energizing gearbox configurations having the double row of planet gears with no planet shafts creates a situation where the axial forces on one gear mesh on a planet are canceled out (opposed) by the opposite helical interface on the other gear mesh on each planet. That is, the axial forces on the outer planet from the inner planet cancel with the axial forces on the outer planet from the outer ring, and the axial forces on the inner planet from the outer planet cancel with the axial forces on the inner planet from the inner ring. The result is much lower axial forces on the planet than would be the case with a planetary gearbox having a single row of planets.

While the axial forces on the planets cancel, the axial forces on the input, inner, and outer rings do not cancel and other elements, such as for example thrust bearings, can be used to bear the axial load on these elements.

A significant advantage of a single angle helix is that the gearbox can be assembled. A herringbone pattern is very difficult to assemble if not impossible. The single helical angle allows the gears to be slid together axially and the cancellation of the axial forces allows them to operate without shafts or bearings.

When torque is applied to the input ring 138, there is a torsional twisting load transferred to the outer planets 136, in addition to a rotational torque transfer to each of the planets around their individual axes. As a result of the self-energizing (or camming) effect between the inner ring 130 and outer ring 134 through the two rows of planets, the gears on two rows of planets and the inner ring 130 and outer ring 134 are forced into engagement proportionally more as the torque output of the device increases. At a certain length of outer geared planet and a certain reduction ratio, the self-energizing effect which causes the gears to mesh together will have a greater straightening effect on the outer planets than the twisting effect of the input from the input sun gear 138. The length of the longest planets may correspond to an overall width of the device in the axial direction. This combination of width and reduction ratio can be calculated by someone skilled in the art to ensure that the meshing of the outer planets 136 with the outer ring 134 straightens the outer planets 136 when torque is applied to the input gear 138 as a result of the output torque that is transferred from the inner ring 130 to the outer ring 134 which causes the camming effect to push the gears into mesh rather than the separating force of the gears causing them to unmesh which would allow them to twist. Because of the gear ratio of the gearbox, the input torque on the input gear 138 will be significantly lower than the torque transferred through the planets 136 and 132. At a ratio of 7:1, the input torque would be roughly 1/7 of the output torque. As a result, the dominant force in the outer planet 136 will be the load due to the torque transfer from the inner ring 130 to the outer ring 134. The radial load component from the camming effect ensures that the contacting gear tooth of the outer planet 136 is forced radially into the corresponding gear tooth in the outer ring 134. This radial load causes the straightening effect that counteracts the twisting effect due to the input torque from the input gear 138. This effect is stronger with a higher pressure angle in the gear teeth or a higher camming angle due to the resulting increase of radial load in the gears.

The greater the aspect ratio of the pinon length to planet diameter, the less likely the planets are to twist as a result of the twisting force from the sun ring input. This relationship exists for two reasons. Generally speaking, the greater the aspect ratio for a given gearbox OD and width, the smaller the pinon diameter and therefore the higher the reduction ratio. As a general trend, the higher the reduction ratio, the greater the radial forces on the pinons which can be used to generate a deeper mesh between the pinons and the rings as compared to the decreased twisting force that is generated by the input of the sun, because of the increased reduction ratio which requires lower torque at the sun ring input, and therefore the greater the aligning effect. For this reason, it is believed that a planet length-to-diameter ratio of greater than 1:1, 1.5:1, 2:1, 2.5:1, 3:1, 3.5:1, 4:1 is suitable for causing the pinons to self-align when the gearbox is transmitting torque from the sun input to the output ring.

Moreover, a high aspect ratio between planet length and planet diameter allows a low helical angle of gear teeth on the planets to still achieve a high contact ratio (gear mesh overlap). Lower helical angles further reduce axial forces.

Aspect ratios can be greater than 2:1 and can be 3:1 or higher, 4:1 or higher, 5:1 or higher, 6:1 or higher, 7:1 or higher, 8:1 or higher, 9:1 or higher, or 10:1 or higher. In an embodiment, the planets include an aspect ratio of at least 4:1.

In a typical planetary gearbox having a single row of planets, a high aspect ratio will be decreasingly beneficial because the gears will twist and lose torque transmitting ability. Longer gears in a typical gearbox are subject to “knockdown factors” because the planet carrier, for example, will twist and biases torque transfer to one end of the planets. By contrast, self-energizing gearboxes provided in accordance with embodiments herein transmit the torque purely radially, thereby rendering the length of the gears relatively moot, and enabling longer planet lengths without the knockdown issue.

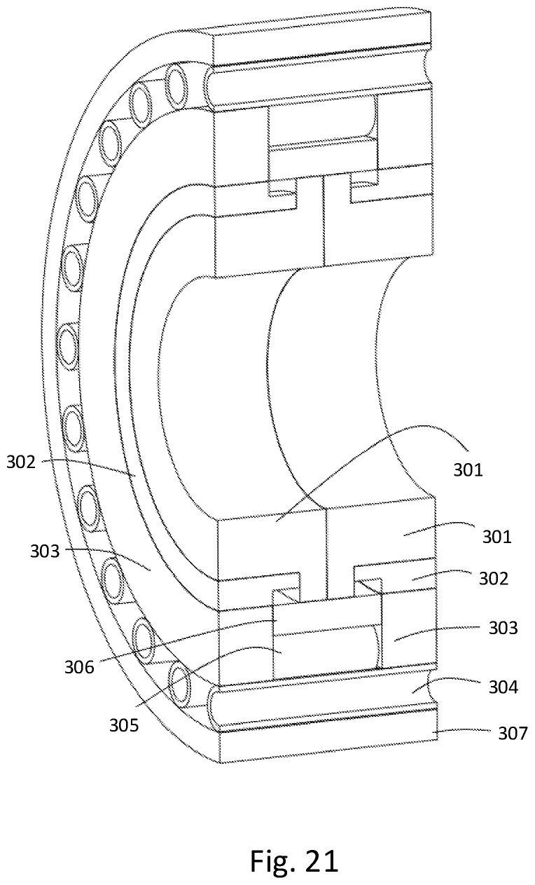

The fact that there is no twisting or tweaking of the gears in this gearbox enables the usage of extra long planets without a substantial decrease in expected torque output. FIG. 21 illustrates an example gearbox configuration having lengthened outer planet gear lengths and including a dual-motor input.

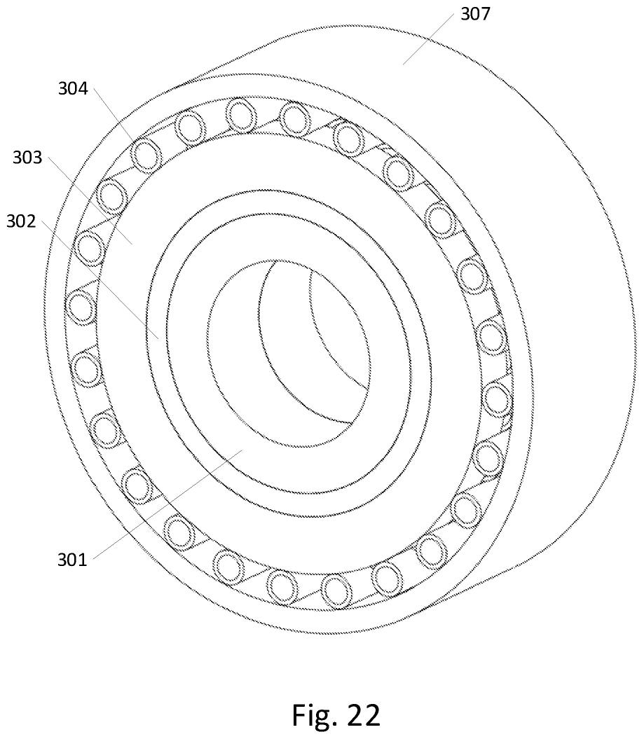

The embodiment shown in FIGS. 21-22 encompasses sun input at both ends of the longer planets. This allows two motors to symmetrically drive one gearbox. The motors have an outer rotor design and the stators are fixed to the extrawide inner ring. Specifically, as shown in FIG. 21, the gearbox comprises motor stators 301 defining an interior of the gearbox. Motor rotors 302 surround the motor stators 301 and are fixedly secured to an input ring 303 that drives outer planets 304. The outer planets 304 in turn drive inner planets 305, which engage and move relative to the fixed inner ring 306. The outer planets 304 additionally drive the outer ring output 307.

A gearbox with included motor as shown above can also be formed in a single sided configuration, for example with one or more motors located inside the ID of the small inner ring gear.

Other embodiments comprise only one sun ring at one end. In this configuration, there are two sun rings which are driven by two individual motors. The motor stators are fixed to the inner ring which is fixed in this configuration. The motor rotors are fixed to the input sun rings.

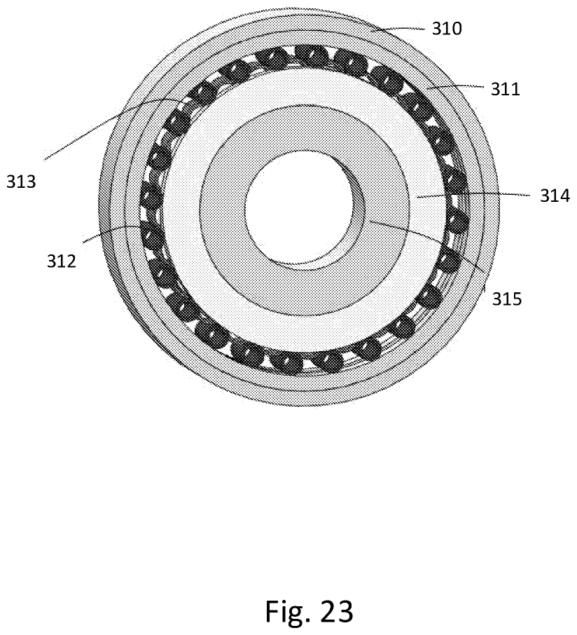

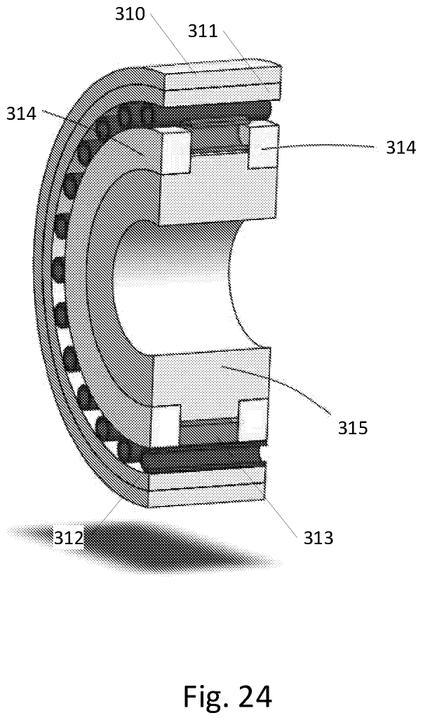

In another embodiment as shown in FIGS. 23-24, there is an outside motor where the stator 310 defines a fixed OD of the device, and the motor rotors 311 are inside the stators 310 and are embodied as an outer ring of the device. In the illustrated embodiment of FIGS. 23-24, the device comprises two outer rings on opposing axial ends of the device, with each outer ring having integrated motor rotors 311. The outer rings (including motor rotors 311) drive outer planets 312, which orbit and drive an inner output ring 314. As illustrated specifically in FIG. 24, it should be understood that the outer planets 312 may drive a plurality of output rings 314, or a single output ring 314 in certain embodiments. Such an embodiment provides a speed increasing configuration. The outer planets 312 additionally engage and rotate together with inner planets 313 which operate together with the outer planets 312 to provide the self-energizing functionality of the gearbox. The inner planets 313 orbit around a fixed inner ring 315.

Both the inside and outside motor configurations can also encompass an inner rotor at both axial ends of the device instead of an outer rotor surrounding and forming an outside diameter of the device.

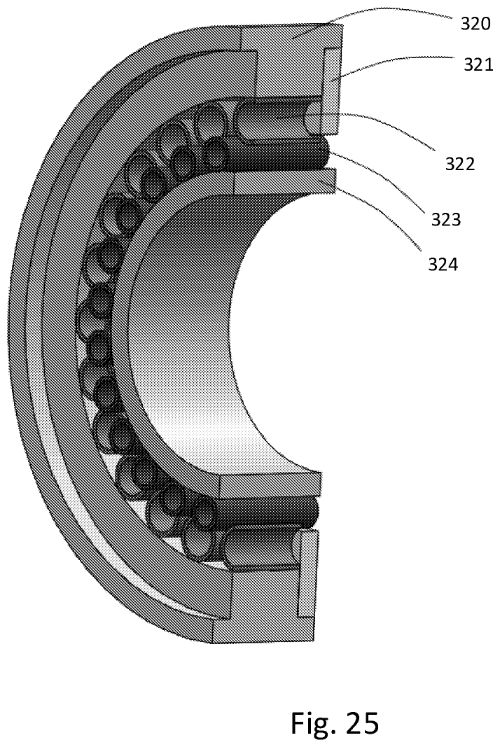

FIGS. 25-28 illustrate an alternative embodiment in which an input ring 322 drives the inner planets 323. In a speed reducer such as the embodiment illustrated in FIGS. 25-28, either the inner ring 324 or the outer ring 320 may be the output. Moreover, as shown in FIGS. 25-28, various embodiments may comprise a single input ring 321 or multiple input rings 321 (e.g., two input rings 321 each positioned on opposing axial ends of the device).

In the illustrated embodiments of FIGS. 25-28, a stationary output ring 320 (which may be embodied as a motor stator) defines an OD of the device. One or more input rings 321 rotate relative to the stationary output ring 320 and drive the inner planets 323. The inner planets 323 rotate relative to and together with the outer planets 322, provide the self-energizing functionality of the device. Those outer planets 322 rotate relative to the stationary output ring 320. The inner planets 323 drive the inner output ring 324.

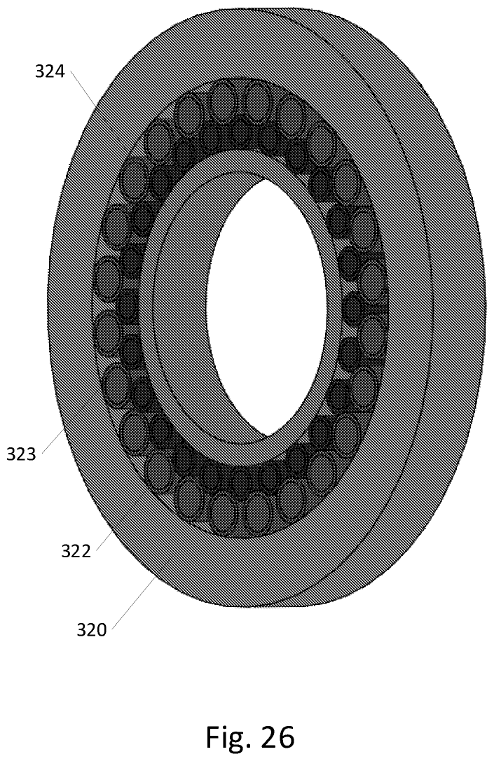

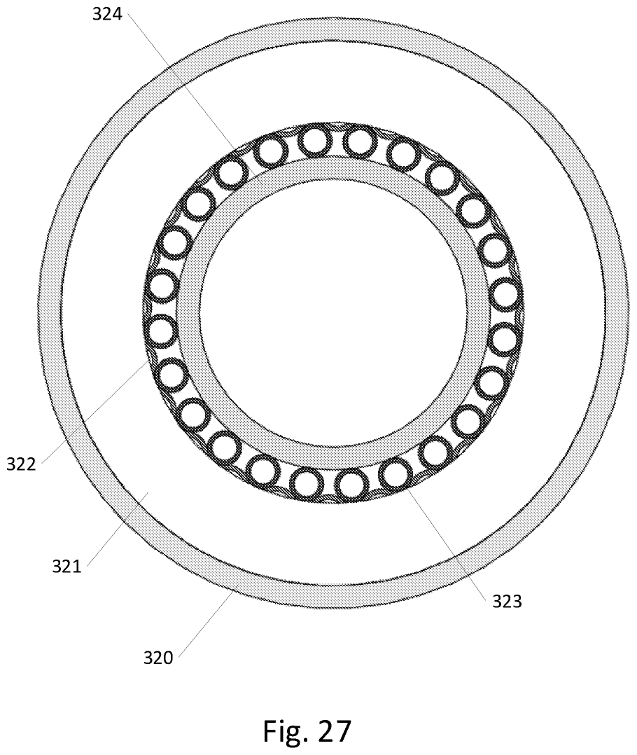

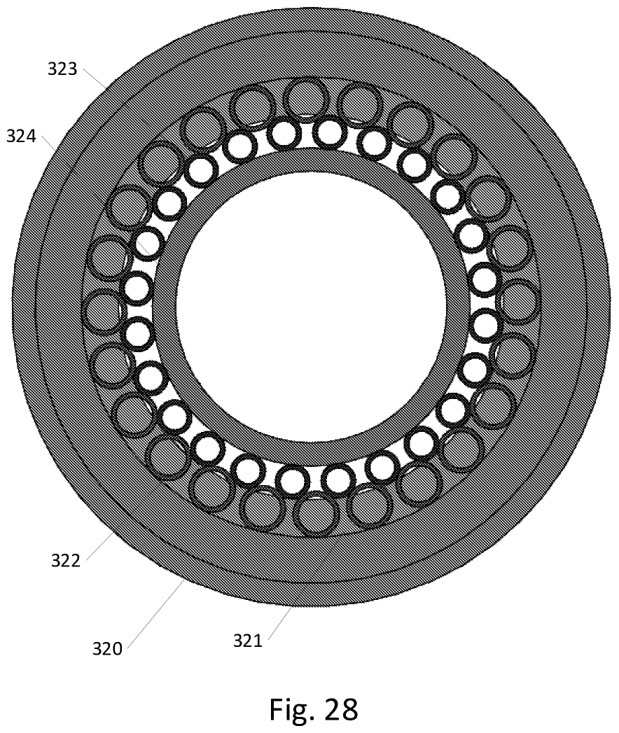

In a further embodiment shown specifically in FIG. 26, there is only a single input ring 321, providing output at one side. The side without the input ring is shown in isometric view of FIG. 26 and the side with the input ring shown in FIG. 27. FIG. 28 shows an example embodiment configured for use with two input rings 321, however an input ring 321 is removed to illustrate the configuration of the planets 322, 323 of the device.

Any one of the inner ring 324, the outer ring 320, and an intermediate ring (such as the input ring 321 shown in FIGS. 25-28 may be the input or the output. The remaining ring that is neither the input ring nor the output ring may be fixed.

In an embodiment with many small planets, the relative motion of the inner ring 324 and outer ring 320 is much smaller that the relative motion of the intermediate ring (e.g., input ring 321) with respect to the inner ring 324 and outer ring 320. Thus, while the intermediate ring can be fixed, with one of the inner ring and outer ring the input and the other the output, this configuration will lead to a small (near 1) speed change ratio with faster internal moving parts than the input and output, and is generally not preferred. With the intermediate ring as the input or output, the device will be a speed increaser if the intermediate ring is the output and a speed decreaser if the intermediate ring is the input.

With multiple intermediate rings, it is also possible to have one intermediate ring be the input and one be the output. Of the inner and outer rings, one can be fixed and the other free spinning. With this arrangement, a gearing ratio different than 1 can be obtained if one of the intermediate rings connects to the inner planets and the other to the outer planets. This gearing ratio can be varied by varying the sizes of these planets. Of note, more variations can be obtained by allowing planets to change in size along their axial length so that the intermediate ring contacts the planets at a different diameter.

Also, both the outer ring and inner ring could be movable and the gearbox will provide a differential between these as output, with a gearing ratio that depends on the movement of the inner and outer rings.

Another possibility is using the self-energizing gearbox as a tool output device. Specifically, if a motor is attached to the sun gear input and if the inner ring is attached to a shaft that turns clockwise in the outer output ring is attached to a shaft that must turn counterclockwise, a reversing differential joint can be created.

It is understood that if the input ring meshes with the outside of the inner planets in an embodiment, for example having first and second portions that mesh with the outer planets and input ring respectively, both portions meshing with the inner ring, then the same principle would apply.

This design may make use of straight cut gear teeth, helical gear teeth, lobes, friction surfaces, or other profiles.

A straight cut gear tooth design like that described above may be advantageous for assembly, with a significantly lower part count when compared to a herringbone design, and a design which allows the gears to be inserted into the assembly from one side.

The straight cut gear tooth design does not have an axial constraint on the planets like the herringbone design, and thus needs some mechanism to constrain the planets axially. This design makes use of fences (not shown in FIG. 20) on either axial end in order to prevent the planets from floating out of the gearbox axially. By crowning the axial end of the planets and adding lubrication, losses due to friction are minimized.

Bearings and shafts can be used in some configurations of the device to locate the planet gears axially. For some configurations, especially smaller devices, it is preferred to eliminate any bearings or shafts in planets.

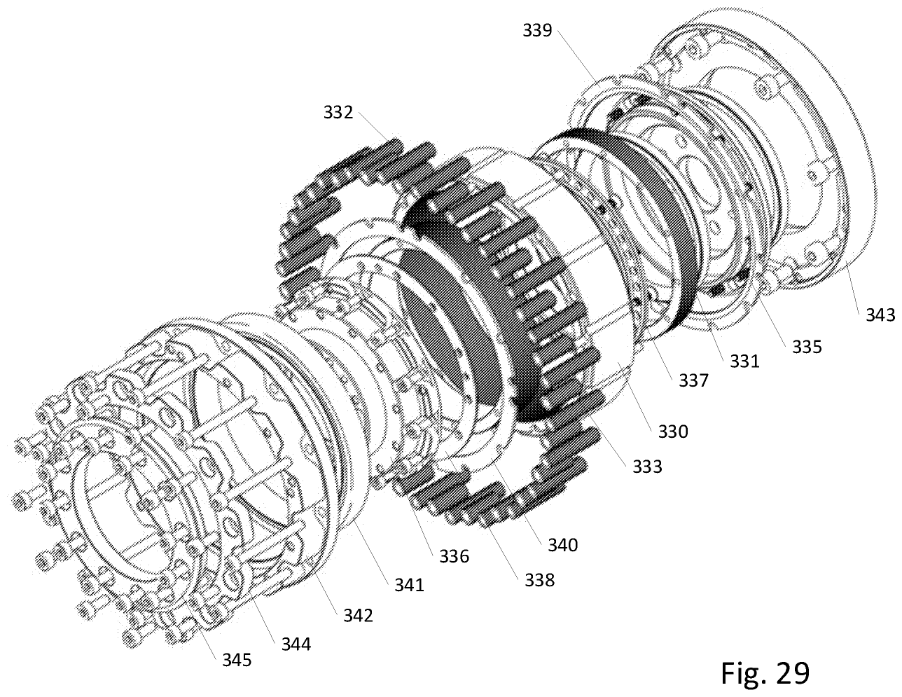

In this case, whether the gears are helical or straight cut, an axial location strategy is required. Shown in FIGS. 29-36 is one possible configuration for providing axial an axial location strategy for the gears via a device. The embodiments of FIGS. 29-36 incorporate a relative curvature between the end of the planets 332, 333 and a fence (e.g., inner fences 337, 338 and/or outer fences 339, 340) at the ends of one or more ring gears (e.g., outer ring 330, inner ring 334, input ring 331). The ends of the planets 332, 333 have a spherical or semi-spherical section on the axial ends thereof, and the fences (e.g., inner fences 337, 338 and outer fences 339, 340) have a corresponding semi spherical shape. Either the axial ends of the planets 332, 333 or the fences (inner fences 337, 338 and/or outer fences 339, 340) may provide a tapered section, however a curved profile on both the axial ends of the planets and the fences may provide ideal functionality. Such a configuration provides a circular line of contact on the axial ends of the planets 332, 333 as they contact the fences (inner fences 337, 338 and/or outer fences 339, 340), said circle being close to the pitch diameter of the gear teeth. This configuration prevents high sliding velocity and wear when axial forces are encountered, such as when device is positioned on end (e.g., such that the central axis of the device is positioned vertically) and gravity is pulling the planets 332, 333 downward toward one of the fences (e.g., the inner fence 337 and output fence 339 or the inner fence on the input side 338 and outer fence on the input side 340). The planets 332, 333 in certain configurations are hollow, and so this contact circle on the planets 332, 333 may be between the ID of the planets' 332, 333 through hole and the roots of the teeth of the planets 332, 333.

The embodiment shown here uses straight cut gears, however the fences 337-340 are operable with helical cut gears in alternative embodiments.

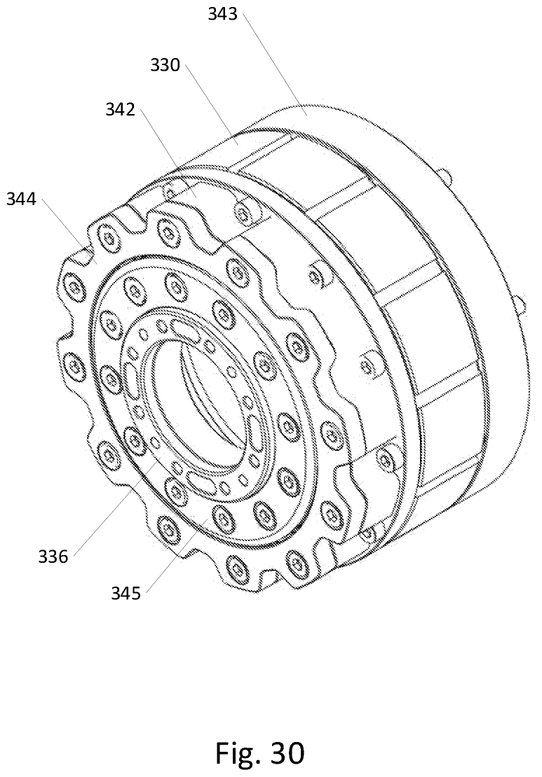

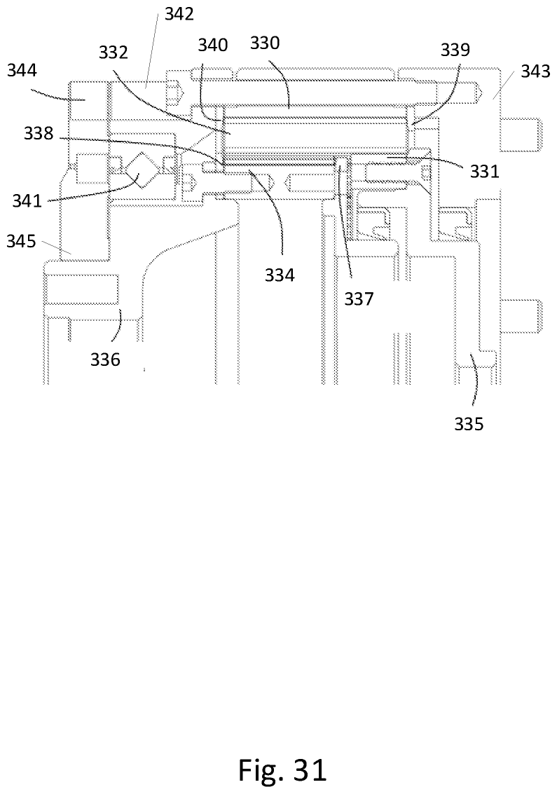

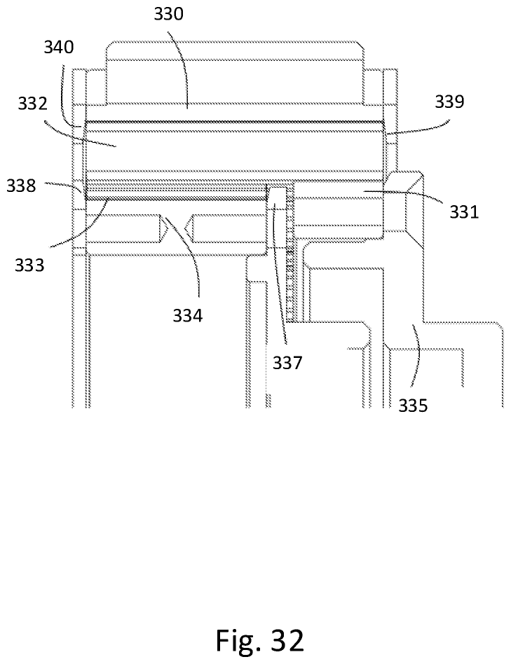

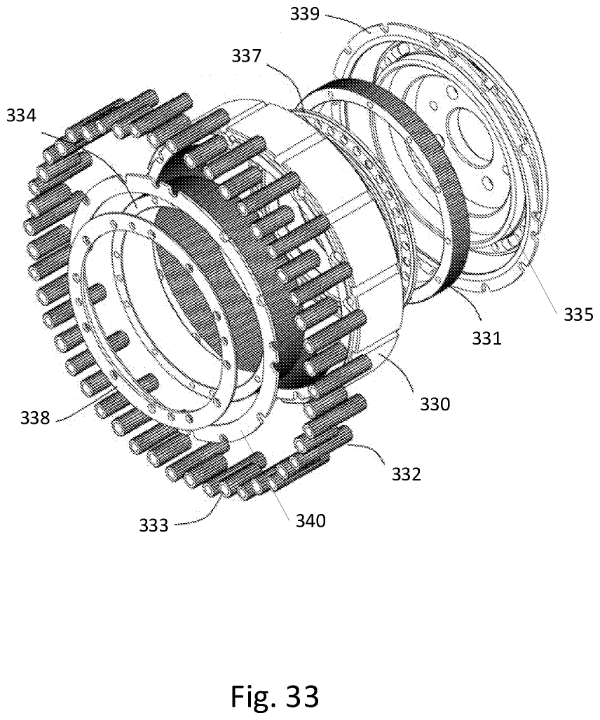

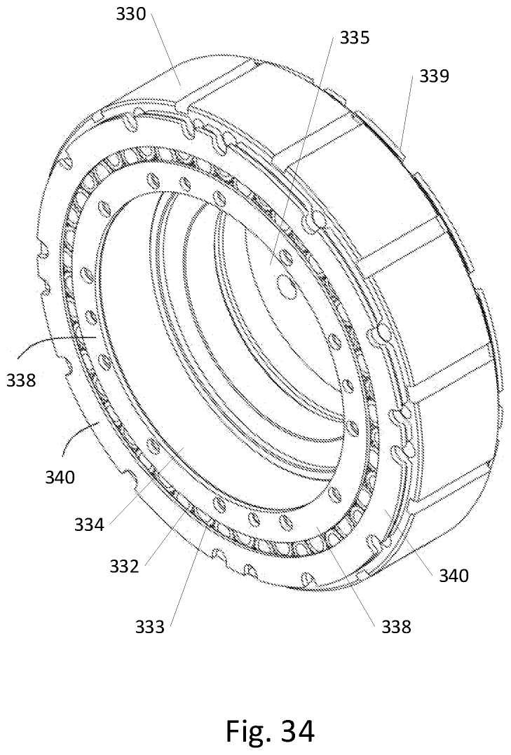

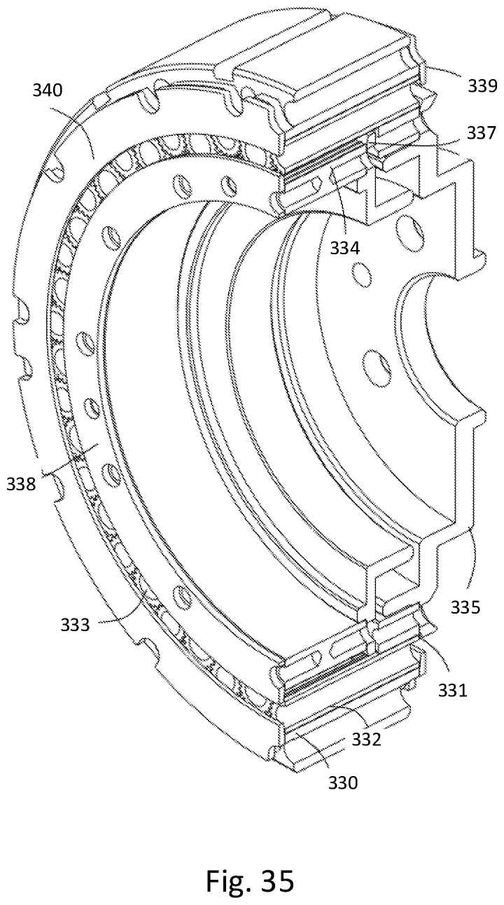

The illustrated embodiments of FIGS. 29-36 encompass a device enclosed within a housing (the housing comprising input side housing portion 343, output side housing portion 342, and outer housing 344, as well as an outer surface of the fixed outer ring 330). FIG. 29 specifically illustrates an exploded view of the device shown in FIG. 30. FIG. 31 illustrates a partial cross-sectional view of the interior of the device, and FIG. 32 illustrates a cross-sectional view with housing components removed. FIG. 33 illustrates a partial exploded view of gearing components (shown assembled in FIG. 34 and in cross-sectional view in FIG. 35). The device of FIGS. 29-36 comprise a sun input ring 331 having an input connector 335 attached thereto. The sun input ring 331 is located centrally within the device and has an outer geared surface. The sun input ring 331 drives outer planets 332, which orbit around the sun input ring 331 and drive the inner planets 333. The outer planets 332 engage and rotate relative to the fixed outer ring 330. Moreover, the inner planets 333 orbit around and drive the inner ring 334, which provides an output for the device. The inner ring 334 has an output 336 connected thereto, which rotates relative to the housing via a bearing configuration (encompassing bearing race 341). The output of the illustrated embodiment is further connected with an output plate 345, which, together with the outer housing 344, constrains movement of the bearing race 341. As shown specifically within the sectional views, the device additionally comprises inner fences 337, 338 configured to axially constrain the movement of the inner planets 333, and outer fences 339, 340 configured to axially constrain the movement of the outer planets 332.

Moreover, as shown the device has planet gears arranged in two rows, in this embodiment the outer planets 332 being axially longer than the inner planets 333. The inner fence 338 which contacts the inner planets 333 can be fixed to the inner ring 334, and the outer fence 340 which contacts the outer planets 332 can be fixed to the outer ring 330. In the illustrated embodiment, fences are provided at both axial ends of the device. In an embodiment as illustrated, where the planets 332, 333 extend to different axial positions on the input axial end, the inner fence 337 and outer fence 339 on the input axial side can be at different axial positions to contact the planets of the respective rows of planets.

The fences 337-340 and planets 332, 333 may have curved faces in contact with one another. The curvature on the axial ends of the planets 332, 333 contacts the curvature on the fences 337-340 such that the contact circle on the end of the planets 332, 333 is outside of the planet through hole and inside of the roots of the planet teeth. Such embodiments provide contact between the planets 332, 333 and fences 337-340 close to the pitch diameter of the planets 332, 333, near where the planets 332, 333 contact an element with respect to which the fence 337-340 is fixed or at rest, so the sliding velocity is minimized. Here, the fences 337-340 are fixed to, and the planets 332, 333 contact, the inner ring 334 and outer ring 330.

### Load Sharing

In a typical planetary gearbox, it is expected that a number of planets greater than 3 would not share the load evenly without very precise tolerances. The self-energizing gearbox has more than 3 planet pairs and must have some mechanism to ensure that load sharing exists to best make use of the additional planets' strength. There are several mechanisms that this gearbox could take advantage of, with several non-limiting mechanisms described here which take advantage of the unusual load distribution of this gearbox.

One non-limiting mechanism of load sharing in the self-energizing gearbox is radial flexibility of the planets, the inner ring, or the outer ring, or any combination of these. Because of the camming effect of the planets described above, there is a strong radial load component within the gearbox, transmitted between the outer ring, planets, and inner ring. If any of these gears has radial flexibility, the gear will be able to compress under the radial load of the camming effect. Because of this flexibility, the tolerance band of the large number of planets can be taken up, allowing the planets to share load. This radial flexibility can come from a number of features or parameters, including, but not limited to, a thin wall, lower material stiffness, or gear tooth root extension such as a radial slot between the teeth.

In order to ensure that there is load sharing between the large number of planets, the previous documentation referred to the need to allow for some sort of deflection in the planets of the gearbox. This deflection could be due to geometry such as thin walled gears or undercuts in the gear teeth, or it could be due to material stiffness in one or more of the gears.

The overall size of the planets of various embodiments, as well as the capability to provide such planets with relatively thin walls (and a hollow interior) to enable radial flexibility of the planets provides adequate flexibility of the planets to enable load sharing in certain embodiments. The planets may be manufactured from a stiff material such as steel, but have thin walls (and a hollow interior) and deflect under load such that the remaining planets could make contact with the associated gears and carry load. Alternatively or additionally, the planets are manufactured from a less stiff material and have a solid construction, but still deflect sufficiently to allow the other planets to begin to share the load. It was found that relatively small differences in the design of the planets could make a significant difference in the amount of load sharing seen in a gearbox.

It should be understood that the design and manufacture of the planets may be provided to withstand high stress and/or high cycle counts. In certain device designs, the planets will sustain the highest concentration of stress of all components of the device. Accordingly, high-strength and/or long-life materials may be utilized for planets in certain implementations.

To maintain high strength within the planets, load sharing can be accomplished instead by reducing the stiffness of the other gears (outer ring, inner ring, and/or sun gears), where there is some ability to reduce strength without affecting the gearbox's critical margins of safety. It has been shown that by manufacturing the planet gears from a stiff material such as steel, and the remaining gears from a less stiff material such as carbon fibre filled PEEK, load sharing can be achieved.

Interestingly, the reduction of stiffness required by this approach is significantly higher than the reduction of stiffness required by changing the materials of the planets alone. In one simulation, the planets had ½ the stiffness of the remaining gears and was shown to be able to sufficiently load share. In order to achieve the same amount of load sharing in a configuration with full-stiffness planets, the remaining gears must have on the order of 1/7 of the stiffness of the planets.

No matter the load sharing mechanism, the higher the radial (camming) load, the more similar the planet load due to a greater load sharing effect. A higher radial load is present with a higher pressure angle of the gear tooth geometry as well as a higher camming angle of the planet contacts.

Another load sharing mechanism results from the 2 level planet construction of the gearbox. As the planets cam onto one another, the non-loaded planet-planet mesh between inner and outer planets acts to stabilize the loaded planet-planet mesh. As a result, it is believed that there is a small amount of shifting in the planet position prior to developing a high enough radial load to “lock” into place. This effect is expected to increase load sharing between the planets and be a stronger effect with a lower pressure angle.

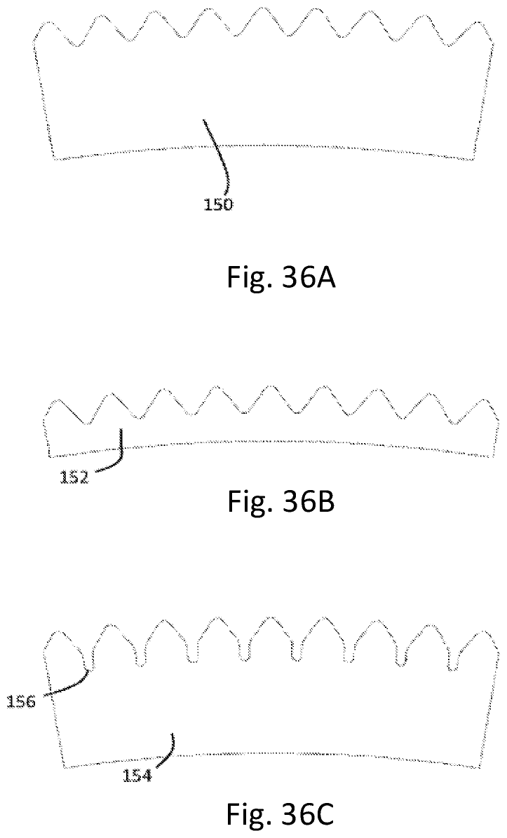

The stress distribution on the self-energized gearbox under load induces a radial load on the planets and geared components. This radial load may further deform one or more of these components and cause the planets to load share effectively, by making the self-energized components more susceptible to deform. This can be achieved by reducing the overall stiffness of the self-energized components (i.e. outer ring, planets and the inner ring). Three different methods could be implemented to achieve this type of change in stiffness (FIG. 36A-36C). A first method uses a change in the material stiffness to reduce overall stiffness of such components; which means the components would deform more under the same radial load as well as become prone to deform under the same tangential load the gear teeth are undertaking. The deformation caused by the radial and tangential load would be advantageous towards a more efficient load sharing and an overall stiffer gearbox. The degree of stiffness that is sufficiently low will depend on the gear tolerances. FIG. 36A shows an example portion of a nominal thickness gear 150 that may be formed of a lower stiffness material. A second method uses a geometric approach (ex. thin walls) to change the overall stiffness of these components. This would make the components less stiff and more sensitive to deform under certain radial load. FIG. 36B shows an exemplary portion of a thinner walled gear 152. A third method uses yet another geometric approach where the wall thickness remains at nominal size, but the tooth geometry is revised to have a radial slot on the root. In this method, both radial and tangential loads have effect on gear flexibility which allows for more effective load sharing. FIG. 36C shows an exemplary portion of a nominal thickness gear 154 with radial slots 156 on the roots.

The disclosed design may eliminate the need for a planet carrier and bearings as the input is supplied by the input ring, circumferential location is supplied by the gears, and axial location may be supplied by, for example, fences, tapered planets, or by portions with different angled gears.

By eliminating the need for a planet carrier and bearings, the tolerance stack-up of these locating elements is eliminated. This allows for much more consistent meshing of greater than three planet gears with the ring gears.

Tolerance stack up elements which are eliminated include the location of the planet carrier pins. The concentricity of the planet carrier, the runout of the bearings, and the eccentricity of the bearing bores in each of the planets with the pitch circle of the gears.

In addition to eliminating these tolerance stack up factors, radial flexibility can be introduced into the design in a number of different ways. Introducing radial flexibility has the effect of reducing the load variation from planet to planet that would result from variations in planet sizes.

Also as a result of eliminating the planet carrier, for example, the planets can be hollow and therefore radially flexible.

### Two Stage Gearbox

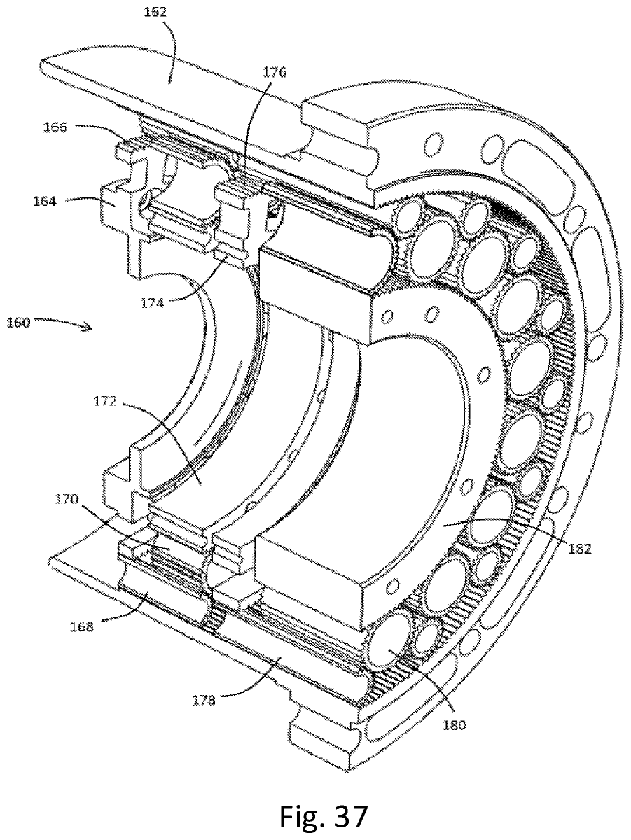

A gearbox as described above can be made a two stage gearbox as shown in FIGS. 37-39. FIG. 37 is an isometric cutaway view of an exemplary two stage gearbox 160. As shown in FIG. 37, an outer housing 162 acts as a common outer stationary gear for both stages. An input ring 164 has an outer surface 166 that meshes with first stage outer gears 168. First stage inner gears 170 mesh with first stage inner ring 172 to drive inner ring 172 with respect to the outer housing 162. This first stage inner ring is connected to, and may be formed in one piece with, a second stage input gear 174 which has an outer surface 176 that meshes with second stage outer gears 178. Second stage inner gears 180 mesh with inner output gear 182 to drive inner output gear 182 relative to outer housing 162, which differential movement provides the output of the two stage gearbox.

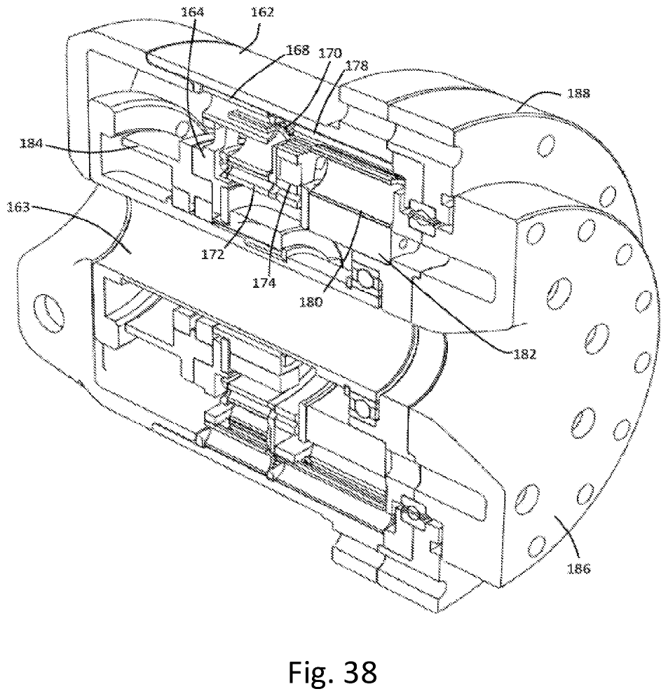

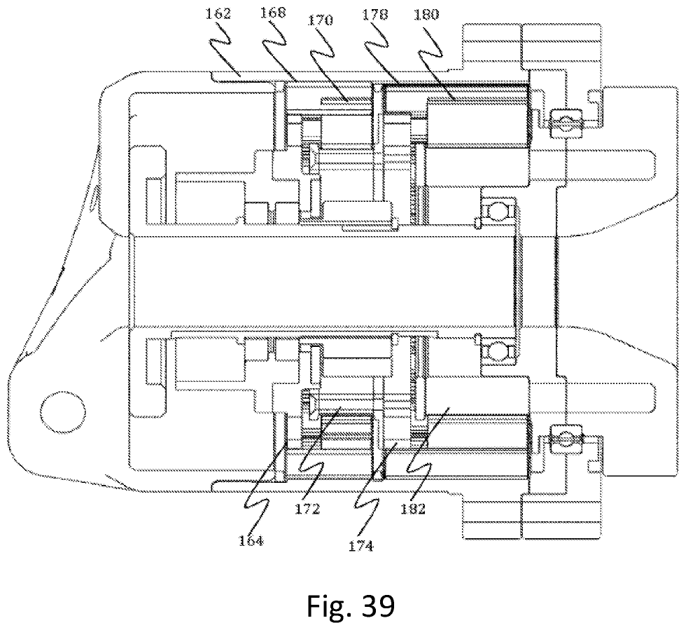

FIG. 38 shows an actuator using the two-stage gearbox shown in FIG. 37. In addition to the components shown in FIG. 37, FIG. 38 shows a flange 184 connected to input ring 164 and inner housing component 163 connected to outer housing 162. An electric motor rotor and stator, not shown, may be connected to the flange 184 and inner housing 163 to drive the flange 184 relative to the inner housing component 163 to drive the two stage gearbox. Also shown in FIG. 38 are an output cap 186 connected to inner output gear 182 and a fixed outer cap 188 connected to outer housing 162. FIG. 39 shows a side cross section view of the embodiment of FIG. 38.

If the outer ring gear of stage one is the same pitch diameter and tooth number and one piece with the other outer ring gear of state two, then the inner ring gear from the first stage is connected to the input gear of the second stage and the inner ring gear of the second stage becomes the output of the second stage.

If the inner ring gear is shared by both stages, then the outer ring gear of the first stage is linked to the input gear of the second stage, and the outer ring gear of the second stage becomes the output of the device. More than two stages can be connected in this way.

### Tapered Embodiment

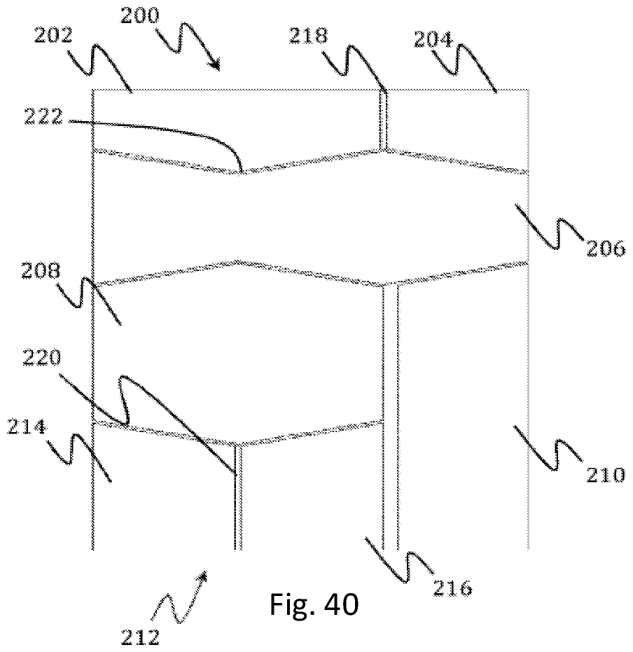

Another exemplary embodiment of the single sided self-energizing gearbox is the tapered design shown in FIGS. 40-43. In this design, the cylindrical gear teeth of the more basic single-sided gearbox design are replaced with tapered gears, with the gear contacts remaining the same as described above, but tapered.

By tapering the gears, the planets become axially constrained and backlash can be reduced or removed by adjusting shims in the locations shown in FIG. 25. The gearbox would otherwise function in the same way as a non-tapered version.

The tapered gear profile is currently difficult to manufacture by traditional gear manufacturing methods such as hobbing or skiving. As such, another method such as but not limited to injection molding, surface milling, powdered metallurgy, or gear rolling, will likely be used. There is also a potential increase in part count due to manufacturing limitations with these tapers.

Either the tapered or non-tapered tooth profiles may make use of straight, or helical gears or lobes. It may be beneficial to use a helix angle on the tapered gears due to the manufacturing method or to optimize strength or noise.

FIG. 40 shows a schematic cross section of a tapered helical self-energized gearbox showing how the gear components are split due to manufacturing and assembly considerations and where shims may be inserted. Note that this is not a true cross section as normally the inner and outer gears would not mesh with the inner and outer races at the same circumferential position. Outer race 200 in this embodiment is split into first component 202 in contact with the outer gears 206 at an axial position corresponding to inner gears 208, and second component 204 in contact with the outer gears 206 at an axial position corresponding to input gear 210. Inner race 212 is also shown split into components 214 and 216. An outer shim 218 is shown between components 202 and 204 of the outer race 200 and an inner shim 220 is shown between components 214 and 216 of inner race.

The longer (outer) gears may also have a split, not shown, at their necks 222 in order to ease manufacturing using injection molding, if injection molding is chosen as the manufacturing method.

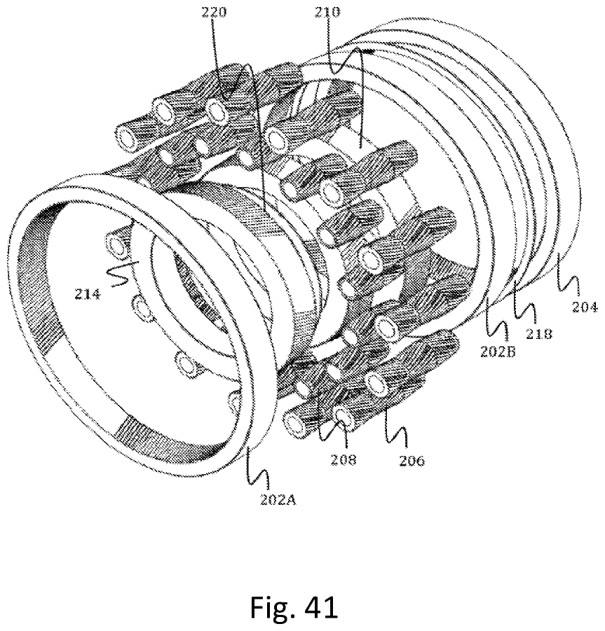

FIG. 41 shows an isometric exploded view of a gearbox as shown schematically in FIG. 40, with the additional change that first component 202 of the outer race is here shown split into two further components 202A and 202B.

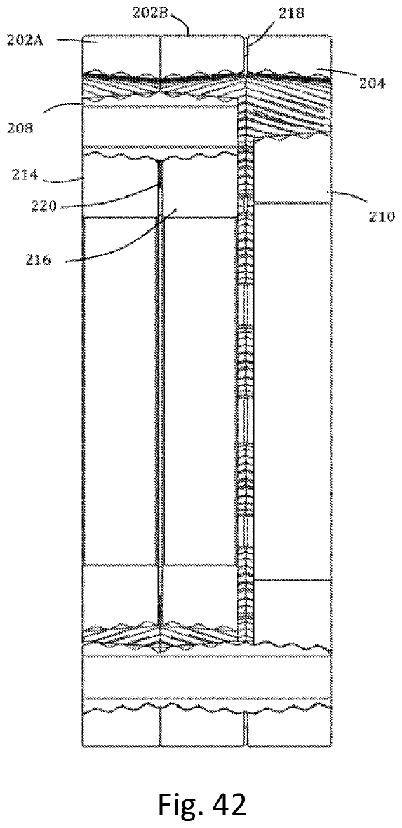

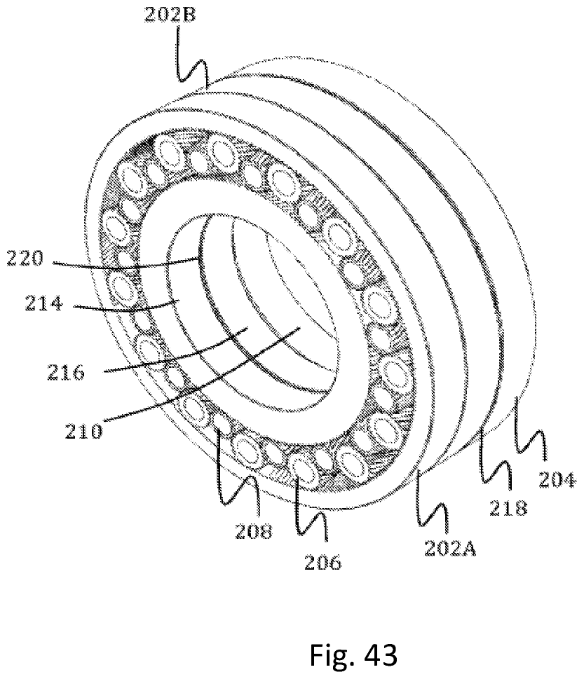

FIG. 42 is a side cutaway view of the gearbox of FIG. 41, with the outer planets removed. FIG. 43 is an isometric view of the gearbox of FIG. 41.

Tapered gears may be used with straight or helical, including herringbone, gears. The taper, in addition to providing some axial location, allows backlash adjustment with shims. Herringbone teeth allow more precise positive axial positioning of the planets and ring gears. Used together, all of the benefits are realized but some applications will benefit from one or the other.

As shown for example in FIG. 20, single sided (non-symmetrical) input is possible without the herringbone or tapered teeth, due to the self energizing effect that causes the teeth to engage and therefore eliminate the twisting of the gear axes.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A gearbox device comprising:
a sun gear defining an inner race on an exterior surface thereof, wherein the sun gear defines an axis between a first end and an opposite second end of the sun gear;
a ring gear defining an outer race on an interior surface thereof, wherein the ring gear is coaxial with the sun gear;
an inner set of planets in geared contact with the inner race of the sun gear;
an outer set of planets in geared contact with the outer race of the ring gear;
wherein each of the inner set of planets is in geared contact with at least two of the outer set of planets and each of the outer set of planets is in geared contact with at least two of the inner set of planets; and
an intermediate gear defining an intermediate race in geared contact with one of: (a) the inner set of planets or (b) the outer set of planets; and
wherein one of the sun gear, the ring gear, and the intermediate gear is held stationary.

2. The gearbox device of claim 1, wherein:
the inner set of planets each have a first axial length measured parallel to the axis of the sun gear; and
the outer set of planets each have a second axial length measured parallel to the axis of the sun gear, wherein the second axial length is different than the first axial length; and
wherein the intermediate race is in geared contact with a longer axial gear set of: (a) the inner set of planets or (b) the outer set of planets.

3. The gearbox device of claim 1, wherein the inner set of planets and the outer set of planets having a length in geared contact, and the inner set of planets, the outer set of planets, the inner race, the outer race, and the intermediate race having respective diameters selected to enable torque provided via one of the sun gear, the ring gear, or the intermediate gear to cause increased radial loading of the inner set of planets and the outer set of planets sufficient to overcome a separating force caused by the torque.

4. The gearbox device of claim 3, wherein the at least one of: (a) the inner set of planets or (b) the outer set of planets each have a length-to-diameter ratio greater than 1:1.

5. The gearbox device of claim 1, wherein the inner set of planets and the outer set of planets each comprise two differently tapered portions.

6. The gearbox device of claim 1, wherein the inner set of planets and the outer set of planets each define helical gears.

7. The gearbox device of claim 6, wherein the inner set of planets and the outer set of planets each define helical gears having a constant helix angle.

8. The gearbox device of claim 6, wherein the inner set of planets and the outer set of planets each define helical gears having differing helix angles along an axial length.

9. The gearbox device of claim 8, wherein the inner set of planets and the outer set of planets each define herringbone gear patterns.

10. The gearbox device of claim 9, wherein the intermediate gear comprises two axially adjacent components each having a respective angled gear surface corresponding to a portion of the herringbone gear patterns, wherein the two axially adjacent components are fastened to one another.

11. The gearbox device of claim 9, wherein the ring gear comprises two axially adjacent components each having a respective angled gear surface corresponding to a portion of the herringbone gear patterns, wherein the two axially adjacent components are fastened to one another.

12. The gearbox device of claim 9, wherein the sun gear comprises two axially adjacent components each having a respective angled gear surface corresponding to a portion of the herringbone gear patterns, wherein the two axially adjacent components are fastened to one another.

13. The gearbox device of claim 1, further comprising at least one inner fence configured to axially constrain the inner set of planets.

14. The gearbox device of claim 1, further comprising at least one outer fence configured to axially constrain the outer set of planets.

15. The gearbox device of claim 1, wherein the inner race, the outer race, the intermediate race, and exterior surfaces of each of the inner set of planets and each of the outer set of planets all define a plurality of gear teeth separated from adjacent gear teeth by gear roots, and wherein at least a portion of the gear roots define radial slots.

16. The gearbox device of claim 1, wherein each of the inner set of planets and each of the outer set of planets are hollow.

17. A multi-stage gearbox device comprising a plurality of gearbox devices as claimed in claim 1, wherein the plurality of gearbox devices are arranged in stages such that a first ring gear of a first gearbox device is connected to and drives a second intermediate gear of a second gearbox device.

18-81. (canceled)
